(19) United States
(12) Patent Application Publication
(10) Pub. No.: US 2023/0413358 A1
(43) Pub. Date: Dec. 21, 2023

(54) Providing Conditional Configuration at an Early Opportunity

(71) Applicant: GOOGLE LLC, Mountain View, CA (US)

(72) Inventor: Chih-Hsiang Wu, Taoyuan City (TW)

(21) Appl. No.: 18/030,495

(22) PCT Filed: Oct. 5, 2021
(86) PCT No.: PCT/US21/53564

§ 371 Date: Apr. 5, 2023

Related U.S. Application Data
(60) Provisional application No. 63/087,830, filed on Oct. 5, 2020.

(51) Int. Cl. H04W 76/19

(52) U.S. Cl. CPC H04W 76/19

(57) ABSTRACT

A method in a RAN is for providing, to a user equipment (UE), a conditional configuration which the UE is to apply when a network-specified condition is satisfied. The method includes determining that a suspended radio connection between the UE and the RAN is to be resumed, the radio connection associated with N cells (1302); obtaining the conditional configuration related to a candidate secondary cell to provide the UE with connectivity over multiple cells (1304); and providing the conditional configuration to the UE prior to the UE resuming the radio connection over at least N cells (1306).

This disclosure relates generally to wireless communications and, more particularly, to providing a conditional configuration to a user equipment (UE) at an early opportunity, when the UE resumes a suspended radio connection with a radio access network (RAN).

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A user device (or user equipment, commonly denoted by the acronym “UE”) in some cases can concurrently utilize resources of multiple network nodes, e.g., base stations, interconnected by a backhaul. When these network nodes support the same radio access technology (RAT) or different RATs, this type of connectivity is referred to as Dual Connectivity (DC) or Multi-Radio DC (MR-DC), respectively. Typically, when a UE operates in DC or MR-DC, one base station operates as a master node (MN), and the other base station operates as a secondary node (SN). The backhaul can support an X2 or Xn interface, for example.

The MN can provide a control-plane connection and a user-plane connection to a core network (CN), whereas the SN generally provides only a user-plane connection. The cells associated with the MN define a master cell group (MCG), and the cells associated with the SN define a secondary cell group (SCG). The UE and the base stations MN and SN can use signaling radio bearers (SRBs) to exchange radio resource control (RRC) messages, as well as non-access stratum (NAS) messages.

There are several types of SRBs that a UE can use when operating in DC. SRB1 and SRB2 resources allow the UE and the MN to exchange RRC messages related to the MN and to embed RRC messages related to the SN, and can be referred to as MCG SRBs. SRB3 resources allow the UE and the SN to exchange RRC messages related to the SN, and can be referred to as an SCG SRB. Split SRBs allow the UE to exchange RRC messages directly with the MN by using radio resources of the MN, the SN, or both the MN and SN. Further, the UE and the base stations (e.g., MN and SN) use data radio bearers (DRBs) to transport data on a user plane. DRBs terminated at the MN and using the lower-layer resources of only the MN can be referred to as MCG DRBs, DRBs terminated at the SN and using the lower-layer resources of only the SN can be referred to as SCG DRBs, and DRBs terminated at the MCG but using the lower-layer resources of both the MN and the SN can be referred to as split DRBs.

A base station (e.g., MN, SN) and/or the CN in some cases causes the UE to transition from one operational state of the Radio Resource Control (RRC) protocol to another state as specified in 3GPP Technical Specifications 36.331 v16.1.0 and 38.331 v16.1.0. More particularly, the UE can operate in an idle state (e.g., EUTRA-RRC_IDLE or NR-RRC IDLE), in which the UE does not have a radio connection with a base station; a connected state (e.g., EUTRA-RRC_CONNECTED or NR-RRC CONNECTED), in which the UE has a radio connection with the base station; or an inactive state (e.g., EUTRA-RRC_IDLE, NR-RRC IDLE, EUTRA-RRC INACTIVE, or NR-RRC INACTIVE), in which the UE has a suspended radio connection with the base station.

UEs can also perform handover procedures (or other types reconfiguration with sync procedures) to switch from one cell to another, whether in SC or DC operation. The UE may handover from a cell of a first base station to a cell of a second base station, or from a cell of a first distributed unit (DU) of a base station to a cell of a second DU of the same base station, depending on the scenario. 3GPP specifications 36.300 v16.2.0 and 38.300 v16.2.0 describe a handover procedure that includes several steps (RRC signaling and preparation) between RAN nodes, which causes latency in the handover procedure and therefore increases the risk of handover failure. This procedure, which does not involve conditions that are checked at the UE, can be referred to as an “immediate” handover procedure.

3GPP specification TS 37.340 (v16.2.0) describes procedures for a UE to add an SN in a single connectivity (SC) scenario or change an SN in a DC scenario. These procedures involve messaging (e.g., RRC signaling and preparation) between radio access network (RAN) nodes. In addition, for both SN or PSCell addition/change and handover, 3GPP specifications 38.300, 36.300 and 37.340 describes “conditional” procedures (i.e., conditional SN or PSCell addition/change and conditional handover). Unlike the “immediate” or “non-conditional” procedures discussed above, these procedures do not add or change the SN or PSCell, or perform the handover, until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B,” or “(Condition A or Condition B) and Condition C”, etc.).

Example procedures that involve conditional configuration include a conditional PSCell addition or change (CPAC or PCP) procedure, a conditional SN addition or change (CSAC) procedure, and a conditional handover (CHO) procedure.

To configure a conditional procedure, the RAN provides the condition to the UE, along with a configuration (e.g., a set of random-access preambles, etc.) that will enable the UE to communicate with the appropriate base station, or via the appropriate cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied.

When the RAN and the UE resume a previously suspended radio connection, and when the RAN has a conditional configuration related to connectivity over multiple cells (e.g., dual connectivity, carrier aggregation), the RAN and the UE currently must complete the resume procedure, which typically involves a procedure for reconfiguring an RRC connection, before the RAN can provide the conditional configuration to the UE. As a result, there is a delay between the time when conditional configuration is available at the RAN and the time when the RAN attempts to provide this configuration to the UE.

### SUMMARY

An example embodiment of the techniques of this disclosure is a method in a radio access network (RAN) for providing, to a user equipment (UE), a conditional configuration which the UE is to apply when a network-specified condition is satisfied. The method can be implemented by processing hardware and includes determining that a suspended radio connection between the UE and the RAN is to be resumed, the radio connection associated with N cells; obtaining the conditional configuration related to a candidate secondary cell to provide the UE with connectivity over multiple cells; and providing the conditional configuration to the UE prior to the UE resuming the radio connection over at least N cells.

Another example embodiment of these techniques is a base station comprising processing hardware and configured to implement the method above.

Still another example embodiment of these techniques is a method in a UE for obtaining a conditional configuration which the UE is to apply when a network-specified condition is satisfied. The method can be implemented by processing hardware and includes suspending a radio connection between the UE and a radio access network (RAN), the radio connection associated with N cells; transmitting, to the RAN, a request to resume the suspended radio connection; and receiving, from the RAN and prior to resuming the radio connection over at least N cells, the conditional configuration for establishing connectivity with the RAN over multiple cells.

Yet another example embodiment of these techniques is a UE comprising processing hardware and configured to implement the method above.

### BRIEF DESCRIPTION OF THE DRAWINGS

FIG. 1A is a block diagram of an example system in which a RAN and a UE can implement the techniques of this disclosure for providing and receiving, respectively, conditional configuration at an early opportunity;

FIG. 1B is a block diagram of another example wireless communication network, with multiple pairs of base station potentially supporting DC connectivity;

FIG. 1C is a block diagram of an example base station in which a centralized unit (CU) and a distributed unit (DU) can operate in the system of FIG. 1A;

FIG. 2 is a block diagram of an example protocol stack according to which the UE of FIG. 1A can communicate with base stations of FIG. 1A;

FIG. 3 is a messaging diagram of an example scenario in which a RAN provides a conditional SN configuration in a command to resume a suspended radio connection, to a UE that operated in single connectivity prior to suspension of the radio connection;

FIG. 4A is a messaging diagram of an example scenario in which a RAN provides a conditional SN configuration along with a new SN configuration in an RRC resume command, to a UE that operated in dual connectivity prior to suspension of the radio connection;

FIG. 4B is a messaging diagram of an example scenario in which a RAN provides a conditional SN configuration along with a new SN configuration in an RRC container, after the UE has resumed the radio connection with the MN but not with the SN;

FIG. 5A is a messaging diagram of an example scenario in which a RAN provides a new SN configuration enclosing a conditional SN configuration in an RRC resume command, to a UE that operated in dual connectivity prior to suspension of the radio connection, where the conditional and non-conditional configurations pertain to the same base station;

FIG. 5B is a messaging diagram of an example scenario in which a RAN provides a new SN configuration enclosing a conditional SN configuration in an RRC container, after the UE has resumed the radio connection with the MN but not with the SN, where the conditional and non-conditional configurations pertain to the same base station;

FIG. 6 is a messaging diagram of an example scenario in which a RAN provides a conditional SN configuration in a command to resume a suspended radio connection, to a UE that operated in dual connectivity with a different MN prior to suspension of the radio connection;

FIG. 7 is a messaging diagram of an example scenario in which a RAN provides a conditional configuration for a distributed unit (DU) in a command to resume a suspended radio connection, to a UE that operated in dual connectivity with a different DU prior to suspension of the radio connection;

FIG. 8 is a messaging diagram of an example scenario in which a RAN provides a conditional configuration for a secondary cell in a command to resume a suspended radio connection, to a UE that operated only on a primary cell prior to suspension of the radio connection;

FIG. 9 is a flow diagram of an example method for resuming a suspended a radio connection and providing conditional configuration to a UE, which can be implemented in a master node (MN) of FIG. 1A;

FIG. 10 is a flow diagram of an example method for processing a conditional configuration, which can be implemented in a UE of FIG. 1A;

FIG. 11 is a flow diagram of an example method for determining whether a UE should indicate that an RRC reconfiguration is completed, depending on whether the RAN provided conditional and/or non-conditional configuration, which can be implemented in a UE of FIG. 1A;

FIG. 12 is a flow diagram of an example method for determining whether a UE should indicate that an RRC reconfiguration is completed, depending on whether the RAN provided a conditional configuration related to a secondary node or a primary secondary cell, which can be implemented in a UE of FIG. 1A;

FIG. 13 is a flow diagram of an example method for providing a conditional configuration to a UE, which can be implemented in a base station of FIG. 1A; and

FIG. 14 is a flow diagram of an example method for processing a conditional configuration received from a RAN, which can be implemented in a UE of FIG. 1A.

### DETAILED DESCRIPTION OF THE DRAWINGS

Generally speaking, the RAN of this disclosure generates a conditional configuration related to a potential connection that involves multiple cells, such as a dual connectivity (DC) connection or a carrier aggregation (CA) connection, and provides the conditional configuration to the UE prior to the UE resuming the suspended radio connection over the one or multiple cells associated with the suspended radio connection. For example, when the UE operates in SC prior to suspension of the radio connection, the RAN can provide the conditional configuration in the command to resume the radio connection (e.g., RRC resume). When the UE operates in DC prior to suspension of the radio connection, the MN can provide the conditional configuration along with the new configuration for the secondary node in the command to resume the radio connection. In some cases, when the UE operates in DC prior to suspension of the radio connection but the RAN releases the lower layers of the connection to the SN prior to resuming the radio connection, the UE can resume the radio connection with the MN, and the MN can provide the conditional configuration along with the new configuration for the secondary node in a message from the command to resume the connection (e.g., in an RRC Container message).

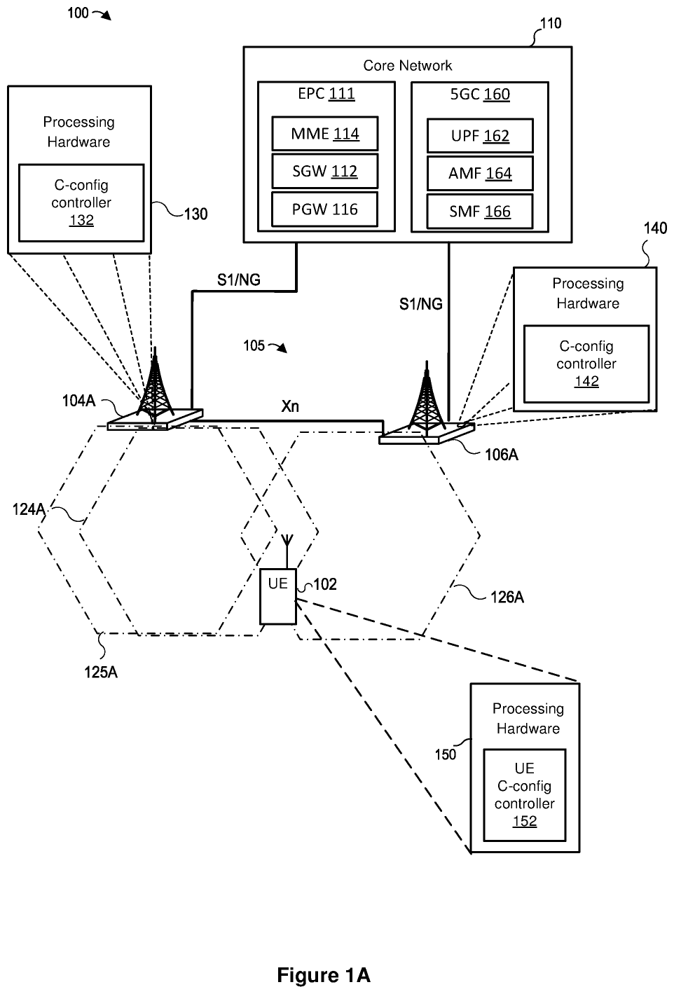

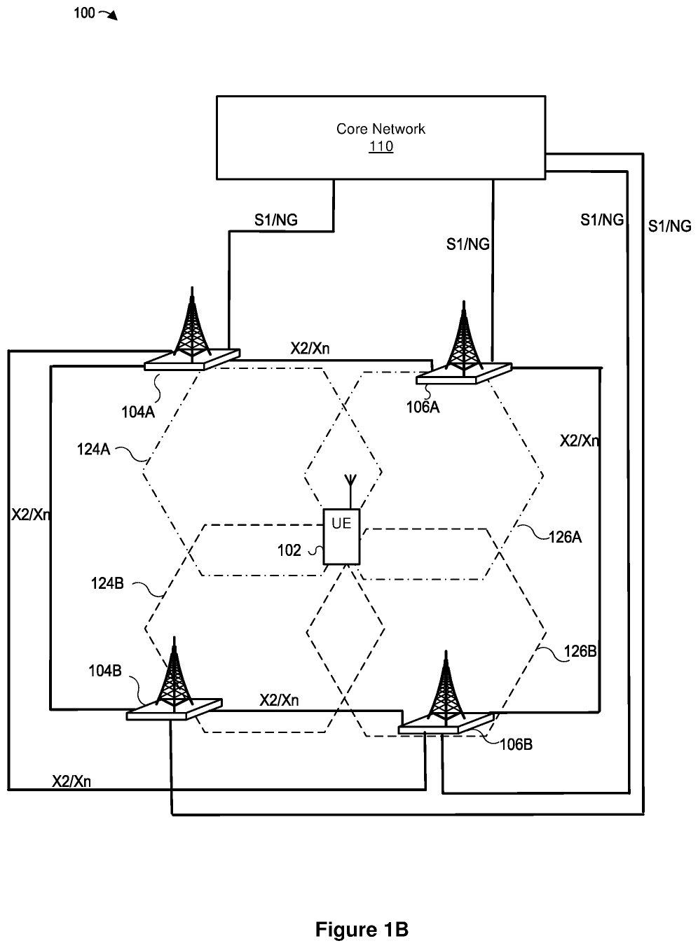

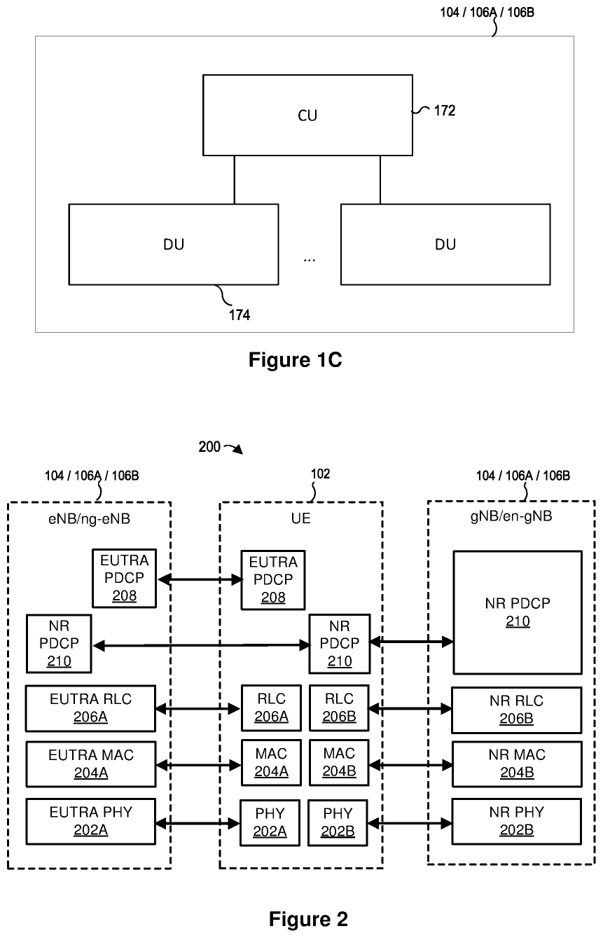

Prior to discussing several example scenarios in which a RAN and/or a UE implements these techniques, example an example wireless communication system is considered with reference to FIGS. 1A-1C, and an example protocol stack which the RAN and the UE can utilize is considered with reference to FIG. 2.

Referring first to FIG. 1A, an example wireless communication system 100 includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116. The S-GW 112 in general is configured to transfer user-plane packets related to audio calls, video calls, Internet traffic, etc., and the MME 114 is configured to manage authentication, registration, paging, and other related functions. The P-GW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104A supports a cell 124A and optionally a cell 125A, and the base station 106A supports a cell 126A. The cells 124A and 126A can partially overlap, so that the UE 102 can communicate in DC with the base station 104A and the base station 106A operating as a master node (MN) and a secondary node (SN), respectively. The cells 124A and 125A can partially overlap, so that the UE 102 can communicate in carrier aggregation (CA) of carrier frequencies (or called component carriers) of the cells 124A and 125A with the base station 104A. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes a conditional configuration controller 132 configured to manage conditional configuration for one or more conditional procedures such as CHO, CPAC, or CSAC, when the base station 104A operates as an MN.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes a conditional configuration controller 142 configured to manage conditional configurations for one or more conditional procedures such as CHO, CPAC, or CSAC, when the base station 106A operates as an SN.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE conditional configuration controller 152 configured to manage conditional configuration for one or conditional procedures.

More particularly, the conditional configuration controllers 132, 142, and 152 can implement at least some of the techniques discussed with reference to the messaging and flow diagrams below to receive conditional configuration, release the conditional configuration in response to certain events, apply the conditional configuration, etc. Although FIG. 1A illustrates the conditional configuration controllers 132 and 142 as separate components, in at least some of the scenarios the base stations 104A and 106A can have similar implementations and in different scenarios operate as MN or SN nodes. In these implementations, each of the base stations 104A and 106A can implement both the conditional configuration controller 132 and the conditional configuration controller 142 to support MN and SN functionality, respectively.

In operation, the UE 102 can use a radio bearer (e.g., a DRB or an SRB) that at different times terminates at the MN 104A or the SN 106A. The UE 102 can apply one or more security keys when communicating on the radio bearer, in the uplink (from the UE 102 to a BS) and/or downlink (from a base station to the UE 102) direction. The UE in some cases can use different RATs to communicate with the base stations 104A and 106A. Although the examples below may refer specifically to specific RAT types, 5G NR or EUTRA, in general the techniques of this disclosure also can apply to other suitable radio access and/or core network technologies.

FIG. 1B depicts an example wireless communication system 100 in which communication devices can implement these techniques. The wireless communication system 100 includes a UE 102, a base station 104A, a base station 104B, a base station 106A, a base station 106B and a core network (CN) 110. The UE 102 initially connects to the base station 104A. The base stations 104B and 106B may have similar processing hardware as the base station 106A. The UE 102 initially connects to the base station 104A.

In some scenarios, the base station 104A can perform immediate SN addition to configure the UE 102 to operate in dual connectivity (DC) with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, e.g., communicate with the base station 104A using 5G NR and communicate with the base station 106A using EUTRA, communicate with the base station 104A using EUTRA and communicate with the base station 106A using 5G NR, or communicate with the base stations 104A and 106A using 5G NR.

At some point, the MN 104A can perform an immediate SN change to change the SN of the UE 102 from the base station 106A (source SN, or “S-SN”) to the base station 104B (target SN, or “T-SN”) while the UE 102 is in DC with the MN 104A and the S-SN 106A. In another scenario, the SN 106A can perform an immediate PSCell change to change the PSCell of the UE 102 to the cell 126A. In one implementation, the SN 106A can transmit a configuration changing the PSCell to cell 126A to the UE 102 via a signaling radio bearer (SRB) (e.g., SRB3) for the immediate PSCell change. In another implementation, the SN 106A can transmit a configuration changing the PSCell to the cell 126A to the UE 102 via the MN 104A for the immediate PSCell change. The MN 104A may transmit the configuration immediately changing the PSCell to the cell 126A to the UE 102 via SRB1.

In other scenarios, the base station 104A can perform a conditional SN Addition procedure to first configure the base station 106B as a C-SN for the UE 102, i.e. conditional SN addition or change (CSAC). At this time, the UE 102 can be in single connectivity (SC) with the base station 104A or in DC with the base station 104A and the base station 106A. If the UE 102 is in DC with the base station 104A and the base station 106A, the MN 104A may determine to perform the conditional SN Addition procedure in response to a request received from the base station 106A, in response to one or more measurement results received from the UE 102 or obtained by the MN 104A from measurements on signals received from the UE 102, based on artificial intelligence or big data prediction (e.g., using collected mobility history data of the UE 102), or blindly. In contrast to the immediate SN Addition case discussed above, the UE 102 does not immediately attempt to connect to the C-SN 106B. In this scenario, the base station 104A again operates as an MN, but the base station 106B initially operates as a C-SN rather than an SN.

More particularly, when the UE 102 receives a configuration for the C-SN 106B, the UE 102 does not connect to the C-SN 106B until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-SN 106B, so that the C-SN 106B begins to operate as the SN 106B for the UE 102. Thus, while the base station 106B operates as a C-SN rather than an SN, the base station 106B is not yet connected to the UE 102, and accordingly is not yet servicing the UE 102. In some implementations, the UE 102 may disconnect from the SN 106A to connect to the C-SN 106B.

In yet other scenarios, the UE 102 is in DC with the MN 104A (via a PCell) and SN 106A (via a PSCell other than cell 126A and not shown in FIG. 1A). The SN 106A can perform conditional PSCell addition or change (CPAC) to configure a candidate PSCell (C-PSCell) 126A for the UE 102. If the UE 102 is configured a signaling radio bearer (SRB) (e.g., SRB3) to exchange RRC messages with the SN 106A, the SN 106A may transmit a configuration for the C-PSCell 126A to the UE 102 via the SRB, e.g., in response to one or more measurement results which may be received from the UE 102 via the SRB or via the MN 104A or may be obtained by the SN 106A from measurements on signals received from the UE 102. In case of via the MN 104A, the MN 104A receives the configuration for the C-PSCell 126A and transmits the configuration to the UE 102. In contrast to the immediate PSCell change case discussed above, the UE 102 does not immediately disconnect from the PSCell and attempt to connect to the C-PSCell 126A.

More particularly, when the UE 102 receives a configuration for the C-PSCell 126A, the UE 102 does not connect to the C-PSCell 126A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-PSCell 126A, so that the C-PSCell 126A begins to operate as the PSCell 126A for the UE 102. Thus, while the cell 126A operates as a C-PSCell rather than a PSCell, the SN 106A may not yet connect to the UE 102 via the cell 126A. In some implementations, the UE 102 may disconnect from the PSCell to connect to the C-PSCell 126A.

In some scenarios, the condition associated with CSAC or CPAC can be signal strength/quality, which the UE 102 detects on the C-PSCell 126A of the SN 106A or on a C-PSCell 126B of C-SN 106B, exceeding a certain threshold or otherwise corresponding to an acceptable measurement. For example, when the one or more measurement results the UE 102 obtains on the C-PSCell 126A are above a threshold configured by the MN 104A or the SN 106A or above a pre-determined or pre-configured threshold, the UE 102 determines that the condition is satisfied. When the UE 102 determines that the signal strength/quality on the C-PSCell 126A of the SN 106A is sufficiently good (again, measured relative to one or more quantitative thresholds or other quantitative metrics), the UE 102 can perform a random access procedure on the C-PSCell 126A with the SN 106A to connect to the SN 106A. Once the UE 102 successfully completes the random access procedure on the C-PSCell 126A, the C-PSCell 126A becomes a PSCell 126A for the UE 102. The SN 106A then can start communicating data (user-plane data or control-plane data) with the UE 102 through the PSCell 126A. In another example, when the one or more measurement results the UE 102 obtains on the C-PSCell 126B are above a threshold configured by the MN 104A or the C-SN 106B or above a pre-determined or pre-configured threshold, the UE 102 determines that the condition is satisfied. When the UE 102 determines that the signal strength/quality on the C-PSCell 126B of the C-SN 106B is sufficiently good (again, measured relative to one or more quantitative thresholds or other quantitative metrics), the UE 102 can perform a random access procedure on the C-PSCell 126B with the C-SN 106B to connect to the C-SN 106B. Once the UE 102 successfully completes the random access procedure on the C-PSCell 126B, the C-PSCell 126B becomes a PSCell 126B for the UE 102 and the C-SN 106B becomes a SN 106B. The SN 106B then can start communicating data (user-plane data or control-plane data) with the UE 102 through the PSCell 126B.

In various configurations of the wireless communication system 100, the base station 104A can be implemented as a master eNB (MeNB) or a master gNB (MgNB), and the base station 106A or 106B can be implemented as a secondary gNB (SgNB) or a candidate SgNB (C-SgNB). The UE 102 can communicate with the base station 104A and the base station 106A or 106B (106A/B) via the same RAT such as EUTRA or NR, or different RATs. When the base station 104A is an MeNB and the base station 106A is an SgNB, the UE 102 can be in EUTRA-NR DC (EN-DC) with the MeNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an MeNB and the base station 106A is a C-SgNB for the UE 102, the UE 102 can be in SC with the MeNB. In this scenario, the MeNB 104A may or may not configure the base station 106B as another C-SgNB to the UE 102.

In some cases, an MeNB, an SeNB or a C-SgNB is implemented as an ng-eNB rather than an eNB. When the base station 104A is a Master ng-eNB (Mng-eNB) and the base station 106A is a SgNB, the UE 102 can be in next generation (NG) EUTRA-NR DC (NGEN-DC) with the Mng-eNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an Mng-NB and the base station 106A is a C-SgNB for the UE 102, the UE 102 can be in SC with the Mng-NB. In this scenario, the Mng-eNB 104A may or may not configure the base station 106B as another C-SgNB to the UE 102.

When the base station 104A is an MgNB and the base station 106A/B is an SgNB, the UE 102 may be in NR-NR DC (NR-DC) with the MgNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an MgNB and the base station 106A is a C-SgNB for the UE 102, the UE 102 may be in SC with the MgNB. In this scenario, the MgNB 104A may or may not configure the base station 106B as another C-SgNB to the UE 102.

When the base station 104A is an MgNB and the base station 106A/B is a Secondary ng-eNB (Sng-eNB), the UE 102 may be in NR-EUTRA DC (NE-DC) with the MgNB and the Sng-eNB. In this scenario, the MgNB 104A may or may not configure the base station 106B as a C-Sng-eNB to the UE 102. In this scenario, the Sng-eNB 106A may configure cell 126A as a C-PSCell to the UE 102. When the base station 104A is an MgNB and the base station 106A is a candidate Sng-eNB (C-Sng-eNB) for the UE 102, the UE 102 may be in SC with the MgNB. In this scenario, the MgNB 104A may or may not configure the base station 106B as another C-Sng-eNB to the UE 102.

The base stations 104A, 106A, and 106B can connect to the same core network (CN) 110 which can be an evolved packet core (EPC) 111 or a fifth-generation core (5GC) 160. The base station 104A can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. The base station 106A can be implemented as an EN-DC gNB (en-gNB) with an S1 interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104A, 106A, and 106B can support an X2 or Xn interface.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 124B, so that the UE 102 can communicate in DC with the base station 104A (operating as an MN) and the base station 106A (operating as an SN) and, upon completing an SN change, with the base station 104A (operating as MN) and the SN 104B. More particularly, when the UE 102 is in DC with the base station 104A and the base station 106A, the base station 104A operates as an MeNB, a Mng-eNB or a MgNB, and the base station 106A operates as an SgNB or a Sng-eNB. The cells 124A and 126B can partially overlap. When the UE 102 is in SC with the base station 104A, the base station 104A operates as an MeNB, a Mng-eNB or a MgNB, and the base station 106B operates as a C-SgNB or a C-Sng-eNB. When the UE 102 is in DC with the base station 104A and the base station 106A, the base station 104A operates as an MeNB, a Mng-eNB or a MgNB, the base station 106A operates as an SgNB or a Sng-eNB, and the base station 106B operates as a C-SgNB or a C-Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

FIG. 1C depicts an example distributed implementation of a base station such as the base station 104A, 104B, 106A, or 106B. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an (C-) SN RRC controller 142 configured to manage or control one or more RRC configurations and/or RRC procedures when the base station 106A operates as an SN or a candidate SN (C-SN). The base station 106B can have hardware same as or similar to the base station 106A. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106A operates as a MN, an SN or a candidate SN (C-SN). The process hardware may include further a physical layer controller configured to manage or control one or more physical layer operations or procedures.

FIG. 2 illustrates, in a simplified manner, an example radio protocol stack 200 according to which the UE 102 may communicate with an eNB/ng-eNB or a gNB (e.g., one or more of the base stations 104A, 104B, 106A, 106B). In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP sublayer 210 over the EUTRA RLC sublayer 206A.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages, for example. On a user plane, the EUTRA PDCP sublayer 208 and the NR PDCP sublayer 210 can provide DRBs to support data exchange.

In scenarios where the UE 102 operates in EUTRA/NR DC (EN-DC), with the base station 104A operating as an MeNB and the base station 106A operating as an SgNB, the wireless communication system 100 can provide the UE 102 with an MN-terminated bearer that uses the EUTRA PDCP sublayer 208, or an MN-terminated bearer that uses the NR PDCP sublayer 210. The wireless communication system 100 in various scenarios can also provide the UE 102 with an SN-terminated bearer, which uses only the NR PDCP sublayer 210. The MN-terminated bearer can be an MCG bearer or a split bearer. The SN-terminated bearer can be an SCG bearer or a split bearer. The MN-terminated bearer can be an SRB (e.g., SRB1 or SRB2) or a DRB. The SN-terminated bearer can an SRB or a DRB.

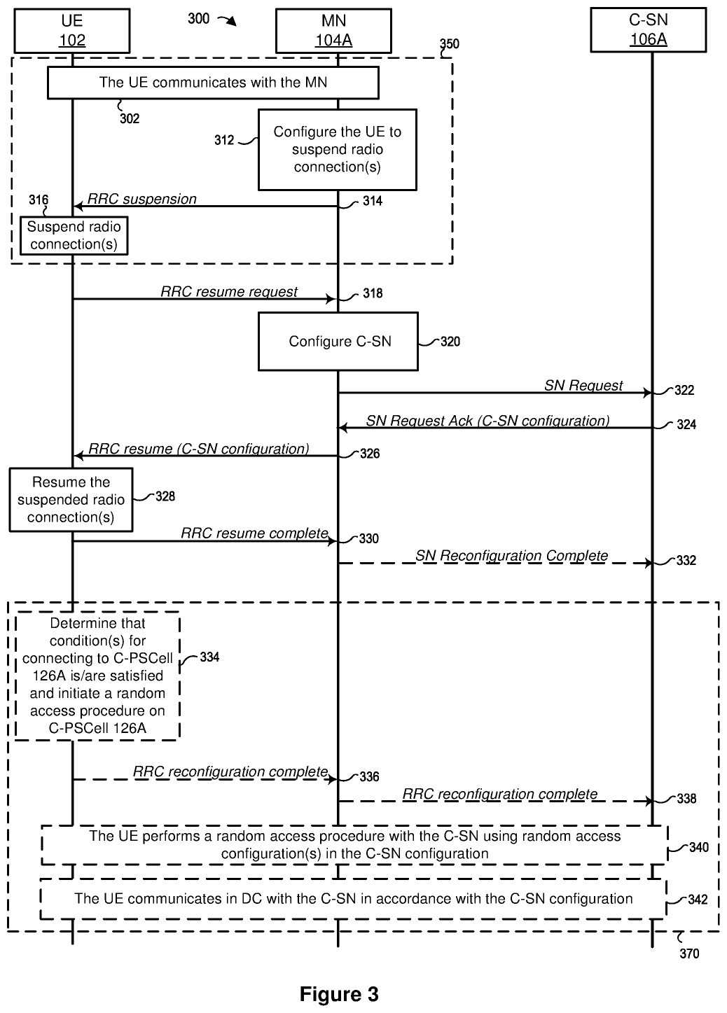

Now referring to FIG. 3, the base station 104A in a scenario 300 operates as an MN, and the base station 106A operates as a C-SN. Initially, the UE 102 communicates 302 data and control signals with the MN 104A (e.g., via PCell 124A). For example, the data includes UL PDUs and/or DL PDUs and the control signals includes signals transmitted by the UE 102 on a physical uplink control channel (PUCCH). In this example scenario, the UE 102 initially is in SC with the base station 104A. In other scenarios, such as those discussed below, the UE 102 can be in DC with the base station 104A and another base station.

At some point, the MN 104A determines 312 that it should configure the UE 102 to suspend the radio connection with the MN 104A. The MN 104A in DC scenarios can determine that it should suspend radio connections between the UE 102 and the MN 104A as well as the SN. In response to the determination, the MN 104A sends 314 an RRC suspension message to the UE 102, so as to cause the UE 102 to suspend the radio connection with the MN 104A (or with the MN 104A as well as the SN, if the UE 102 operates in DC). In response to receiving 314 the RRC suspension message, the UE 102 suspends 316 the radio connection(s). The UE 102 can transition to an inactive or idle state in response to the RRC suspension message. In some implementations, the RRC suspension message can include a SuspendConfig IE, an RRC-InactiveConfig-r15 IE, or a ResumeIdentity-r13 IE. The events 302, 312, 314 and 316 are collectively referred to in FIG. 3 as a radio connection suspension procedure 350. In some scenarios and implementations, the UE 102 may perform a radio connection suspension procedure with base station 104B instead of the MN 104A, similar to the radio connection suspension procedure 350 (e.g., when the UE receives an RRC suspension message from the MN 104B but then moves into the area of coverage of the MN 104A).

After suspending 316 the radio connection(s), the UE 102 can perform an RRC resume procedure to resume the suspended radio connection(s), e.g., in response to determining to initiate a data transmission with the MN 104A, or in response to a Paging message received from the MN 104A. In response to the determination, the UE 102 can send 318 an RRC resume request message to the MN 104A via the cell 124A, so that the MN 104A can configure the UE 102 to resume the suspended radio connection(s).

The MN 104A determines 320 that it should configure a C-SN for the UE 102 after receiving 318 the RRC resume request message. The MN 106A can make this determination based on one or more measurement results obtained by the MN 106A from measurements on signals, control channels or data channels received from the UE 102, based on history data of the UE 102, or blindly. The MN 104A may store the history data of the UE 102 or obtain the history data of the UE 102 from the CN 110 or a particular server. For example, the history data may reveal a particular probability that the UE 102 is configured in DC with the MN 104A and the SN 106A while the UE 102 communicates with the MN 104A. If the particular probability is above a predetermined threshold, the MN 104A makes the determination 320. If the particular probability is below a predetermined threshold, the MN 104A determines not to configure a C-SN for the UE 102.

In another example, the history data can include mobility data. The mobility data includes cells where the UE 102 camps, visits or connects with at different times and/or dates. The mobility data can also include positioning data with different times. The MN 104A may predict that the UE 102 may move toward coverage of the base station 106A based on the history data. The MN 104A can use an artificial intelligence algorithm with the history data to predict that the UE 102 may enter coverage of the base station 106A in a short time period. If the MN 104A predicts that the UE 102 will not enter coverage of the base station 106A, the MN 104A may determine not to configure the base station 106A as a C-SN for the UE 102.

In response to this determination 320, the MN 104A sends 322 an SN Request message to a base station 106A to request that the base station 106A operate as a C-SN for the UE 102. In response to the SN Request message, the C-SN 106A generates a C-SN configuration, includes the C-SN configuration in a SN Request Acknowledge message, and sends 324 the SN Request Acknowledge message to the MN 104A. Then the MN 104A sends 326 an RRC resume message including the C-SN configuration to the UE 102 in response to the RRC resume request message. In response to the RRC resume message, the UE 102 resumes 328 the suspended radio connection(s) and transmits 330 an RRC resume complete message to the MN 104A. The MN 104A may send 332 a SN Reconfiguration Complete message to the C-SN 106A to inform the C-SN 106A that the UE 102 received the C-SN configuration.

In an alternative implementation, however, the MN 104A does not transmit an SN Reconfiguration Complete message to the C-SN 106A because the UE 102 does not immediately apply the C-SN configuration (unlike an immediate or non-conditional SN configuration). In this sense, transmitting an SN reconfiguration complete message at event 332 can be considered premature.

According to the above, the MN 104A can configure the base station 106A as a C-SN for the UE 102 during the RRC resume procedure. The MN 104A can directly configure the base station as a SN for the UE 102 during the RRC resume procedure. However, the UE 102 may fail connecting to the SN 106A because the UE 102 may not yet have entered the coverage area of the base station 106A.

To distinguish the SN Request message of event 322 from an SN Request message for immediate SN addition, the MN 104A may include, in the SN Request message, a certain indication (e.g., an IE) requesting that the base station 106A generate a C-SN configuration. Due to this indication, the base station 106A becomes aware that the MN 104A requests the base station 106A to operate as a C-SN for the UE 102 rather than an SN. Conversely, if the base station 106A receives from an MN (e.g., the MN 104A or another suitable node) an SN Request message that does not include this indication for a UE, the base station 106A becomes aware that the MN requests the base station 106A operate as an SN for the UE rather that the C-SN.

In some implementations, the SN Request and SN Request Acknowledge messages can be SN Addition Request and SN Addition Request Acknowledge messages, respectively. In other implementations, the SN Request and SN Request Acknowledge messages can be SN Modification Request and SN Modification Request Acknowledge messages, respectively.

In some implementations, the MN 104A generates a conditional configuration (e.g., an information element (IE)) including a C-SN configuration and include the conditional configuration in the RRC resume message. The MN 104A may include, in the conditional configuration, condition(s) for connecting C-PSCell 126A. In one implementation, the MN 104A may generate the condition(s), rather than receive the condition(s) in the SN Request Acknowledge message from the C-SN 106A. In this case, the SN 106A does not include condition(s) for connecting the C-PSCell 126A. In another implementation, the MN 104A may generate a portion of the condition(s), or receive a remainder of the condition(s) in the SN Request Acknowledge message from the C-SN 106A.

In some implementations, the condition(s) include signal strength quality condition(s) that can be signal strength/quality, which the UE 102 detects on the C-PSCell 126A of the C-SN 106A, exceeding a certain threshold or better than a PSCell (e.g., PSCell 126B if the UE 102 is DC with the MN 104A and the SN 106B) or otherwise corresponding to an acceptable measurement. When the UE 102 obtains one or more measurement results on the C-PSCell 126A above a threshold configured by the MN 104A or the SN 106A or above a pre-determined or pre-configured threshold, the UE 102 determines that the condition(s) is satisfied. In some implementations, the condition(s) may be similar to event(s) A3, A4, A5 or B1 defined in 3GPP specification 36.331 or 38.331. When the UE 102 detects that the one or more events occur according to the one or more measurement results the UE 102 obtains on the C-PSCell 126A, the UE 102 determines that the one or more conditions are satisfied.

In other implementations, the condition(s) may further include a data stream condition that includes a data stream identity (e.g., quality of service (QoS) flow ID, DRB identity, EPS bearer identity or PDU session identity) in addition to the signal strength/quality condition(s). If the UE 102 needs to transmit data associated to the data stream identity, and the signal strength/quality condition(s) for the C-PSCell 126A is satisfied, the UE 102 determines that the one or more conditions are satisfied. Otherwise, the UE 102 determines that the one or more conditions are not satisfied. When the signal strength/quality condition(s) for the C-PSCell 126A are satisfied, the UE 102 nevertheless can determine that the one or more conditions are not satisfied if the UE 102 does not have data associated with the data stream identity to be transmitted.

In some implementations, the MN 104A may generate an RRC container message (e.g., RRCConnectionReconfiguration message or a RRCReconfiguration message) including the C-SN configuration and then include the RRC container message in the conditional configuration. In other implementations, the MN 104A includes the C-SN configuration in the conditional configuration without generating an RRC container message to enclose the C-SN configuration. In some implementations, the MN 104A may include, in the conditional configuration, a conditional configuration identity which identifies the C-SN configuration or the RRC container message.

In other implementations, the C-SN 106A may determine first condition(s) for connecting the C-PSCell 126A and include the first condition(s) in the C-SN configuration. In one implementation, the MN 104A may not include condition(s) for connecting the C-PSCell 126A in the RRC resume message. In another implementation, the MN 104A may generate second condition(s) for connecting the C-PSCell 126A and includes the condition(s) in the RRC resume message as described above, in addition to that the C-SN 106A include the first condition(s) in the C-SN configuration.

Optionally, the UE 102 can determine 334 that the one or more conditions for connecting to the C-PSCell 126A are satisfied, and then the UE initiates 340 a random access procedure on the C-PSCell 126A in response to this determination. That is, the one or more conditions (“triggering conditions”) triggers the UE 102 to connect to the C-PSCell 126A or to execute the C-SN configuration. However, if the UE 102 does not determine that the condition is satisfied, the UE 102 does not connect to the C-PSCell 126A. In any case, the UE 102 performs 334 the random access procedure with the C-SN 106A via the C-PSCell 126A using random access configuration(s) included in the C-SN configuration. The UE 102 (if the UE 102 is in DC) may disconnect from the SN 106B (i.e., the PSCell and all of SCell(s) of the SN 106B if configured) in response to the event 334 or 340. In response to the determination 334, the UE 102 may transmit 336 an RRC reconfiguration complete message to the MN 104A to inform the MN 104A that the UE 102 is attempting to access, is connecting to or has connected to the C-SN 106A. The MN 104A can forward 338 the RRC reconfiguration message to the C-SN 106A. The UE 102 can transmit the RRC reconfiguration complete message before, after, or during the random access procedure.

In some implementations, the UE 102 may transmit 336 an RRC container response message (e.g., RRCConnectionReconfigurationComplete message, a RRCReconfigurationComplete message) including the RRC reconfiguration complete message to the MN 104A. The MN 104A extracts RRC reconfiguration complete message from the RRC container response message. In other implementations, the UE 102 may transmit 336 an RRC container message (e.g., ULInformationTransferMRDC message) including the RRC reconfiguration complete message to the MN 104A. The MN 104A extracts RRC reconfiguration complete message from the RRC container message.

In some implementations, the MN 104A sends 338 an RRC Transfer message including the RRC reconfiguration complete message to the C-SN 106A. In other implementations, the MN 104A sends 338 an SN Reconfiguration Complete message including the RRC reconfiguration complete message to the C-SN 106A.

In some implementations, the random access procedure can be a four-step random access procedure or a two-step random access procedure. In other implementations, the random access procedure can be a contention-based random access procedure or a contention-free random access procedure. After the UE 102 successfully completes 340 the random access procedure, the C-SN 106A begins to operate as the SN 106A, and the UE 102 begins to operate 342 in DC with the MN 104A and the SN 106A. In particular, the UE 102 communicates 342 with the SN 106A via the C-PSCell 126A (i.e., new PSCell 126A) in accordance with the C-SN configuration.

The events 334, 336, 338 and 340 and 342 are collectively referred to in FIG. 3 as a CSAC procedure 370.

In some implementations, the C-SN 106A identifies the UE 102 if the C-SN 106A finds an identity of the UE 102 in a medium access control (MAC) protocol data unit (PDU) received from the UE 102 in the random access procedure (event 340). The C-SN 106A can include the identity of the UE 102 in the C-SN configuration. In other implementations, the C-SN 106A identifies the UE 102 if the C-SN 106A receives a dedicated random access preamble from the UE 102 in the random access procedure. The C-SN 106A can include the dedicated random access preamble in the C-SN configuration sent 324 earlier.

In some implementations, the MN 104A subsequently may determine that it should release the C-SN configuration after receiving the RRC resume complete message, e.g., because the MN 104A determines the C-SN configuration or the conditional configuration is no longer valid. In response to the determination, the MN 104A can send (not shown) to the UE 102 an RRC message including a release indication (e.g., an IE) which causes the UE 102 to release the C-SN configuration or the conditional configuration. For example, the release indication can include the conditional configuration identity so that the UE 102 can use the conditional configuration identity to identify the C-SN configuration or the conditional configuration. Thus, the UE 102 releases (not shown) the C-SN configuration or the conditional configuration in response to the release indication. Alternatively, the MN 104A can include a mobility IE (e.g., MobilityControlInfo or a ReconfigurationWithSync) in the RRC message instead of the release indication. The UE 102 releases the C-SN configuration or the conditional configuration in response to the mobility IE.

In other implementations, the MN 104A can subsequently determine to update the C-SN configuration or the conditional configuration (i.e., the first C-SN configuration or the first conditional configuration) after receiving the RRC resume complete message, because the MN 104A determines the first C-SN configuration or the first conditional configuration is no longer valid. In response to the determination, the MN 104A can send (not shown) to the UE 102 an RRC message including a second C-SN configuration or a second conditional configuration. The MN 104A obtains the second C-SN configuration or second conditional configuration as described above for the first C-SN configuration or first conditional configuration. The second conditional configuration can include the conditional configuration identity so that the UE 102 can use the conditional configuration identity to identify the first C-SN configuration or the first conditional configuration. Thus, the UE 102 can update (e.g., modify or replace) the first C-SN configuration or the first conditional configuration with the second C-SN configuration or the second conditional configuration.

In yet other implementations, the MN 104A can subsequently determine that it should retain the C-SN 106A for the UE 102 and configure base station 104B as a C-SN for the UE 102. The MN 104A obtains (not shown) a second C-SN configuration or a second conditional configuration associated to the C-SN 106B and send to the UE 102 an RRC message including the second C-SN configuration or second conditional configuration, similarly as described above for the first C-SN configuration or first conditional configuration associated to the C-SN 106A.

In the implementations above, the UE 102 may transmit an RRC response message to the MN 104A in response to the RRC message. In one implementation, the RRC message and RRC response message can be a RRCReconfiguration message and a RRCReconfigurationComplete message, respectively. In another implementation, the RRC message and RRC response message can be a RRCConnectionReconfiguration message and a RRCConnectionReconfigurationComplete message, respectively.

With continued reference to FIG. 3, the C-SN configuration in some implementations can be a complete and self-contained configuration (i.e. a full configuration). The C-SN configuration may include a full configuration indication (an information element (IE) or a field) that identifies the C-SN configuration as a full configuration. The UE 102 in this case can directly use the C-SN configuration to communicate with the SN 106A without relying on an SN configuration. On the other hand, the C-SN configuration in other cases can include a “delta” configuration, or one or more configurations that augment a previously received SN configuration. The UE 102 in this case can use the delta C-SN configuration together with the SN configuration to communicate with the SN 106A.

The C-SN configuration can include multiple configuration parameters for the UE 102 to apply when communicating with the SN 106A via a C-PSCell 126A. The multiple configuration parameters may configure radio resources for the UE 102 to communicate with the SN 106A via the C-PSCell 126A and zero, one, or more candidate secondary cells (C-SCells) of the SN 106A. The multiple configuration parameters may configure zero, one, or more radio bearers. The one or more radio bearers can include an SRB and/or one or more DRBs.

In some implementations, the C-SN configuration can include a group configuration (CellGroupConfig) IE that configures the C-PSCell 126A and zero, one, or more C-SCells of the SN 106A. In one implementation, the C-SN configuration may include a radio bearer configuration. In another implementation, the C-SN configuration may not include a radio bearer configuration. For example, the radio bearer configuration can be a RadioBearerConfig IE, DRB-ToAddModList IE or SRB-ToAddModList IE, DRB-ToAddMod IE or SRB-ToAddMod IE. In various implementations, the C-SN configuration can be an RRCReconfiguration message, RRCReconfiguration-IEs, or the CellGroupConfig IE conforming to 3GPP TS 38.331. The full configuration indication may be a field or an IE conforming to 3GPP TS 38.331. In this case, the RRC reconfiguration complete message can be an RRCReconfigurationComplete message conforming to 3GPP TS 38.331.

In other implementations, the C-SN configuration can include an SCG-ConfigPartSCG-r12 IE that configures the C-PSCell 126A and zero, one, or more C-SCells of the SN 106A. In some implementations, the C-SN configuration is an RRCConnectionReconfiguration message, RRCConnectionReconfiguration-IEs, or the ConfigPartSCG-r12 IE conforming to 3GPP TS 36.331. The full configuration indication may be a field or an IE conforming to 3GPP TS 36.331. In this case, the RRC reconfiguration complete message can be an RRCConnectionReconfigurationComplete message conforming to 3GPP TS 36.331.

Still referring to FIG. 3, the C-SN 106A in some cases can include the CU 172 and one or more DU 174 as illustrated in FIG. 1C. The DU 174 may generate the C-SN configuration or part of the C-SN configuration and send the C-SN configuration or part of the C-SN configuration to the CU 172. In case the DU 174 generates a portion of the C-SN configuration, the CU 172 may generate rest of the C-SN configuration.

When the MN 104A is implemented as a gNB, the RRC resume request, RRC resume, and RRC resume complete messages are RRCResumeRequest, RRCResume and RRCResumeComplete messages, respectively. When the MN 104A is implemented as an eNB or next generation eNB (ng-eNB), the RRC resume request, RRC resume, and RRC resume complete messages are RRCConnectionResumeRequest, RRCConnectionResume, and RRCConnectionResumeComplete messages, respectively.

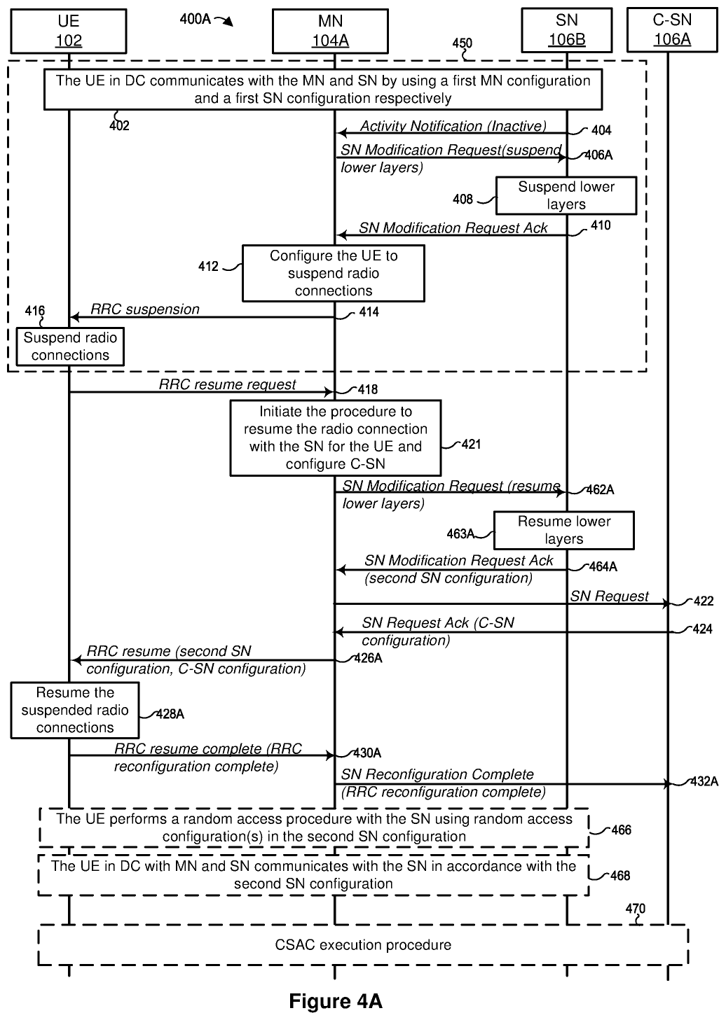

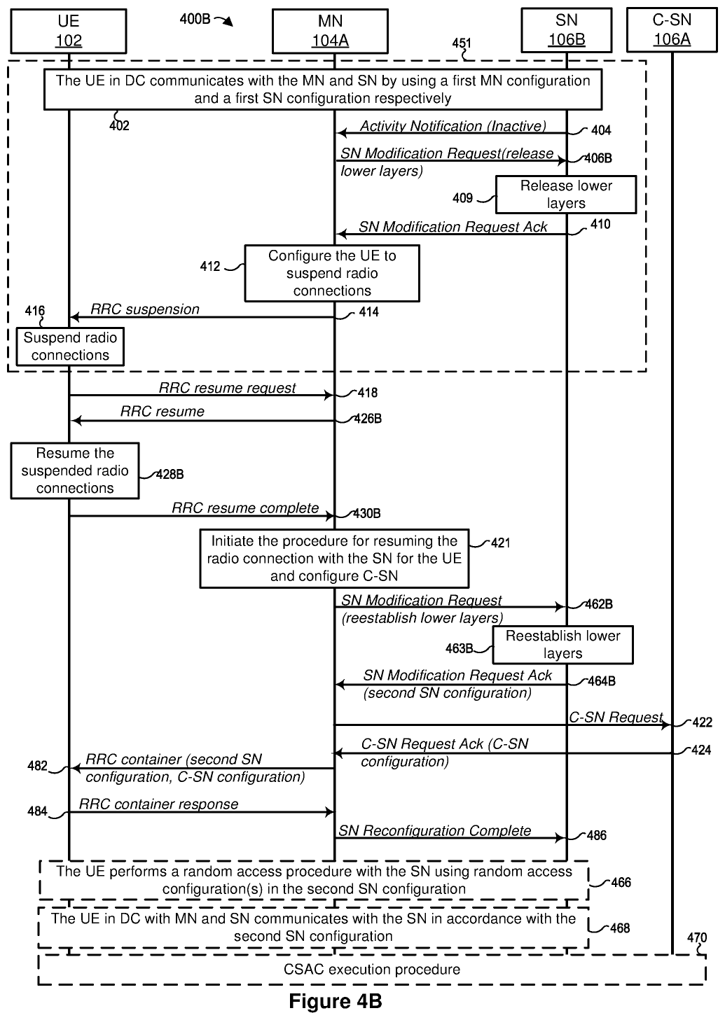

Referring next to FIG. 4A, in a scenario 400A, the base station 104A operates as an MN, the base station 106B operates as an SN, and the base station 106A operates as a C-SN. Events in the scenario 400A similar to those discussed above with respect to the scenario 300 are labeled with similar reference numbers (e.g., with event 302 corresponding to event 402, event 312 corresponding to event 412). Initially, the UE 102 in DC communicates 402 data and control signals with the MN 104A and SN 106B in accordance with a first MN configuration and a first SN configuration, respectively. In some implementations, the UE 102 in DC can communicate 402 UL PDUs and/or DL PDUs via radio bearers which can include SRBs and/or DRBs. The MN 104A and/or the SN 106B can configure the radio bearers to the UE 102.

The MN 104A at some point can detect data inactivity for the UE 102 and, in response, determine 412 that the MN 104A should configure the UE 102 to suspend radio connections with the MN 104A and the SN 106B. For example, the MN 104A can detect data inactivity for the UE 102 based on an indication that the MN 104A receives from the SN 106B. As a more specific example, the SN 106B may detect data inactivity for the UE 102 and in response send 404 an Activity Notification message with an inactive indication to the MN 104A. The MN 104A can then determine that data inactivity exists for the UE 102 based on the received Activity Notification message. In other implementations, the MN 104A can start a data inactivity timer to monitor data activity. In some of these implementations, if the data inactivity timer expires, and the MN 104A did not transmit data to, or receive data from, the UE 102 while the data inactivity timer was running, then the MN 104A detects data inactivity for the UE 102. Conversely, if the MN 104A has data to be transmitted to the UE 102 or receives data from the UE 102 while the data inactivity timer is running, then the MN 104A can restart the data inactivity timer.

After receiving 404 the Activity Notification message, the MN 104A sends 406A to the SN 106B an SN Modification Request message that includes an indication to suspend lower layers (e.g., PHY 202A/202B, MAC 204A/204B, and/or RLC 206A/206B) for the UE 102. In response to the SN Modification Request message, the SN 106B suspends 408 the lower layers and sends 410 an SN Modification Request Acknowledge message to the MN 104. In some implementations, the SN 106B can release resources of lower layers allocated for communication with the UE 102 in response to the indication to suspend lower layers (event 406A). These resources can include software, firmware, memory, and/or processing power that the SN 106B uses to implement functions of the PHY 202A/202B, MAC 204A/204B, and/or RLC 206A/206B layers for communicating with the UE 102. For example, the SN 106B can allocate processing power from an ASIC, DSP and/or CPU of the SN 106B for communicating with the UE 102, and release the allocated processing power in response to the indication to suspend lower layers. In other implementations, the SN 106B retains the resources of lower layers allocated to communicate with the UE 102 and suspend operation of the PHY 202A/202B, MAC 204A/204B, and/or RLC 206A/206B layers. The events 402, 404, 406A, 408, 410, 412, 414, 416 are collectively referred to in FIG. 4A as an MR-DC suspension procedure 450. Alternatively, as discussed below with reference to FIG. 4B, the MN 104A can instruct the SN 106B to release, rather than suspend, the resources of lower layers.

After receiving 418 the RRC resume request message, the MN 104A determines 421 that it should resume the radio connection between the UE 102 and the SN 106B, and the MN 104A determines it should configure the base station 106A as a C-SN for the UE 102. The MN 106A can make this determination based on one or more measurement results obtained by the MN 106A from measurements on signals, control channels, or data channels received from the UE 102, based on history data of the UE 102, or blindly. In response to the determination to resume the radio connection with the SN 106B, the MN 104A can send 462A to the SN 106B an SN Modification Request message including an indication to resume lower layers (e.g., PHY 202A/202B, MAC 204A/204B, and/or RLC 206A/206B) for communicating with the UE 102. The SN 106B resumes 463A the lower layers in response to the indication, and sends 464A to the MN 104A an SN Modification Request Acknowledge message including a second SN configuration in the SN Modification Request Acknowledge message in response to the SN Modification Request message. Alternatively, as discussed with reference to FIG. 4B, the MN 104A can instruct the SN 106B to reestablish lower layers.

In response to the determination to configure the base station 106A as a C-SN for the UE 102, the MN 104A sends 422 an SN Request message to the base station 106A to request that the base station 106A operate as a C-SN for the UE 102. In response to the SN Request message, the C-SN 106A generates a C-SN configuration, includes the C-SN configuration in a SN Request Acknowledge message, and sends 424 the SN Request Acknowledge message to the MN 104A. The MN 104A can send the SN Modification Request message 462A before, during, or after sending the SN Request message 422.

After receiving the second SN configuration and the C-SN configuration, the MN 104A sends 426A an RRC resume message including the new, second SN configuration and the C-SN configuration to the UE 102 in response to the RRC resume request message. The second SN configuration can have a format and content generally similar to the C-SN configuration, but unlike the C-SN configuration, the “regular” SN configuration is not associated with network-specified conditions. Further, depending on the scenario, the second SN configuration can be a full configuration or a delta configuration.

In response to the RRC resume message, the UE 102 resumes 428A the suspended radio connections with the MN 104A and the SN 106B, and transmits 430A an RRC resume complete message to the MN 104A. The RRC resume complete message can include an indication that the RRC reconfiguration is complete (e.g., in the form of the RRC Reconfiguration Complete message). The MN 104A accordingly may send 432A an SN Reconfiguration Complete message to the SN 106B to inform the SN 106B that the UE 102 has received the second SN configuration.

At some point after receiving the second SN configuration, the UE 102 can perform 466 a random access procedure on a cell (e.g., the cell 126B or another cell operated by the SN 106B) with the SN 106B to connect to the SN 106B using one or more random access configurations in the second SN configuration. After the UE 102 successfully completes the random access procedure on the cell, the UE 102 can communicate 468 data (user-plane data and/or control-plane data) in DC with both the MN 104A and the SN 106B. Events 466 and 468 are similar to events 340A and 342A. The UE 102 then can perform 470 a CSAC execution procedure with the MN 104A and C-SN 106A, similar to the CSAC procedure 370.

Thus, by sending 426A an RRC resume message with both the SN configuration and the C-SN configuration, the MN 104A eliminates the need for the UE 102 to separately perform a C-SN configuration procedure upon completing the procedure for resuming the connection and sending 430A the RRC resume complete message.

Next, FIG. 4B illustrates a scenario 400B that is generally similar to the scenario of FIG. 4A, but here the UE 102 initially resumes 428B the connection with the MN 104A but the SN 106B. Events in the scenario 400B similar to those discussed above with respect to the scenarios above are labeled with similar reference numbers (e.g., with event 302 corresponding to event 402, event 312 corresponding to event 412). With the exception of the differences illustrated in FIG. 4B and the differences described below, any of the alternative implementations discussed above with respect to the above scenarios (e.g., for messaging and processing) may apply to the scenario 400B.

In this scenario, after receiving 404 the Activity Notification message, the MN 104A sends 406B to the SN 106B an SN Modification Request message that includes an indication to release lower layers (e.g., PHY 202A/202B, MAC 204A/204B, and/or RLC 206A/206B) for the UE 102. In response to the SN Modification Request message, the SN 106 releases the lower layers at event 409 instead of suspending lower layers. More specifically, in some implementations, the SN 106B can release the lower layer resources that are allocated to communicate with the UE 102. These resources can include, for example, software, firmware, memories (e.g., memory hardware or storage space within memory hardware), and/or processing power that the SN 106 uses to implement functions of the PHY 202A/202B, MAC 204A/204B, and/or RLC 206A/206B layers for communicating with the UE 102. For example, the SN 106B can allocate processing power from an ASIC, DSP, and/or CPU of the SN 106B for communicating with the UE 102, and may release the allocated processing power in response to the indication to release the lower layers. In other implementations, the SN 106B can release the first SN configuration in response to the indication to release lower layers. In some implementations, the SN 106B can retain at least one interface identifier (ID) of the UE 102 for exchanging interface messages between the MN 104A and the SN 106 in response to the indication to release lower layers. For example, if the interface between the MN 104A and the SN 106 is an Xn interface (e.g., the Xn interface shown in FIG. 1A), the at least one interface ID can include a first UE XnAP ID allocated by the SN 106, and a second UE XnAP ID allocated by the MN 104A. In another example, if the interface between the MN 104A and the SN 106 is an X2 interface, the at least one interface ID can include a first UE X2AP ID allocated by the SN 106B, and a second UE X2AP ID allocated by the MN 104A.

The events 402, 404, 406B, 409, 410, 412, 414, 416 are collectively referred to in FIG. 4B as an MR-DC release procedure 451. Performing the procedure 451 causes the UE 102 to operate in single connectivity, unlike the procedure 450 of FIG. 4A.

In response to receiving 418 the RRC resume request message, the MN 104A sends 426B an RRC resume message to cause the UE 102 to resume the radio connection with the MN 104A. In response, the UE 102 resumes 428B the suspended radio connection with the MN 104A and transmits 430B an RRC resume complete message to the MN 104A. Unlike the event 430A, the UE 102 does not indicate in the event 430B that the RRC reconfiguration is complete, because the RRC resume message does not include an SN configuration.

The MN 104A then determines 421 that it should resume the radio connection with the SN 106B and configure the base station 106A as a C-SN for the UE 102. To this end, the MN 104A sends 462B to the SN 106B an SN Modification Request message including an indication to reestablish lower layers (e.g., PHY 202A/202B, MAC 204A/204B, and/or RLC 206A/206B) for communicating with the UE 102 instead of resuming lower layers. In response to receiving 462B the SN Modification Request message, the SN 106B reestablishes 463B the lower layers by obtaining (e.g., generating) a full SN configuration and including the full SN configuration in the second SN configuration. In some implementations, the SN 106B can allocate resources of lower layers to communicate with the UE 102 in response to the indication to reestablish lower layers. The resources may include software, firmware, memories, and/or processing power that the SN 106B uses to implement functions of the PHY 202A/202B, MAC 204A/204B, and/or RLC 206A/206B layers for communicating with the UE 102, for example. The SN 106 can allocate processing power from an ASIC, DSP, and/or CPU of the SN 106B for communicating with the UE 102. The full SN configuration can be a complete and self-contained configuration including configurations for operations of the PHY 202A/202B, MAC 204A/204B, and/or RLC 206A/206B layers for communicating with the SN 106B. The SN 106B then sends 464B to the MN 104A an SN Modification Request Acknowledge message including the second SN configuration.

The MN 104B sends 482 an RRC container message including the second SN configuration as well as the C-SN configuration. The UE 102 sends 484 an RRC container response message, which can include an SN reconfiguration complete message, to the MN 104A. The MN 104 in response can transmit 486 an SN reconfiguration complete message to the SN 106B.

Unlike the scenario of FIG. 4A, here the MN 104A transmits 482 the C-SN configuration after, rather than before, receiving 430B the RRC resume complete message. However, in both FIGS. 4A and 4B, the UE 102 receives the C-SN configuration prior to reestablishing the connection with both the MN 104A and the SN 106B, i.e., prior to reestablishing 468 dual connectivity. Thus, by sending 482 an RRC container message with both the SN configuration and the C-SN configuration, the MN 104A eliminates the need for the UE 102 to separately perform a C-SN configuration procedure and the SN configuration procedure.

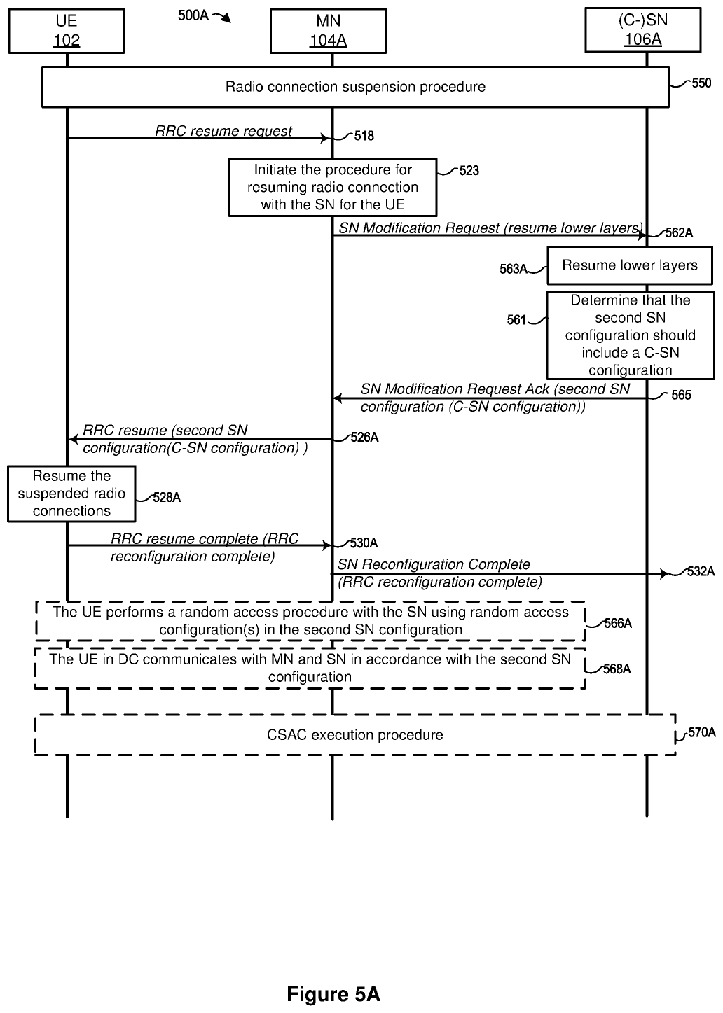

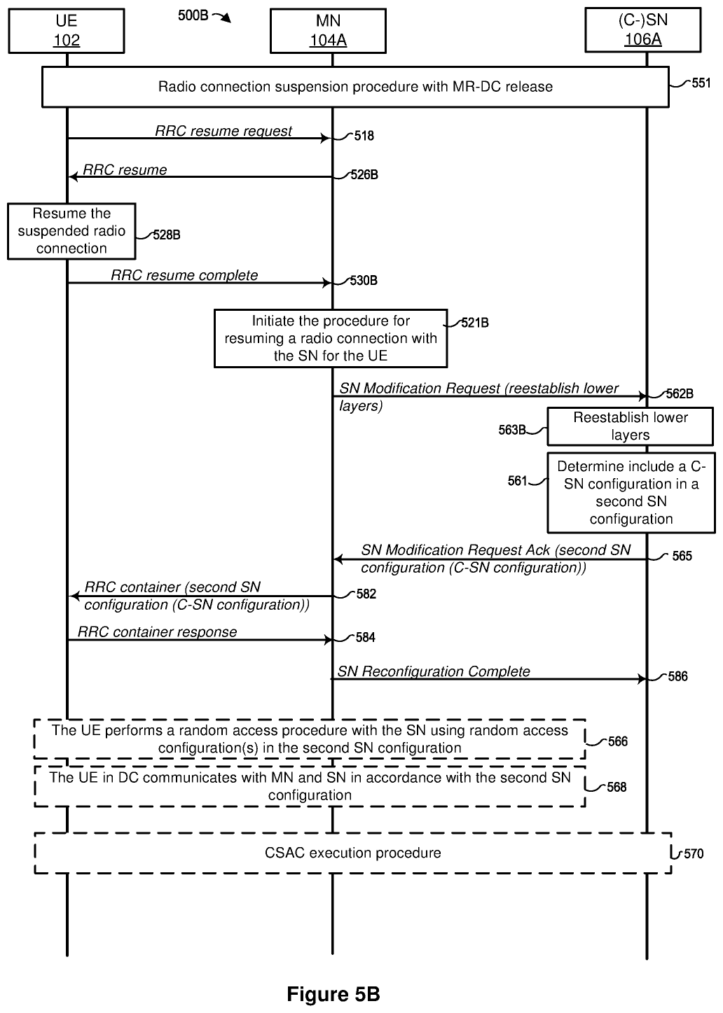

Next, FIG. 5A illustrates a scenario 500A that is generally similar to the scenario 400A, but here the cell on which the UE 102 operated in DC prior to suspension of the radio connection and the cell of the conditional configuration are associated with the same base station 106A. Thus, the base station 106A operates as both the SN and the C-SN.

Events in the scenario 500A similar to those discussed above with respect to the scenarios above are labeled with similar reference numbers; with the exception of the differences illustrated in FIG. 5A and the differences described below, any of the alternative implementations discussed above with respect to the above scenarios may apply to the scenario 500A.

After the MN 104A receives 518 a request to resume the suspend radio connections from the UE 102, the MN 104A initiates 523 a procedure for resuming the radio connection between the UE 102 and the SN 106A. To this end, the MN 104A sends 562A an SN Modification Request message including an indication to resume lower layers. The SN 106A resumes 563A the lower layers, similar to the scenario of FIG. 4A, and then determines 561 that the SN 106A should generate a C-SN configuration for the UE 102 and includes the C-SN configuration in the SN configuration. The SN 106A then sends 565 an SN Modification Request Acknowledge message including a new, second SN configuration (which can be partial or complete). The second SN configuration includes or encloses the C-SN configuration. The MN 104A in turn sends 526A an RRC resume message including the new, second SN configuration enclosing the C-SN configuration to the UE 102.

Thus, the MN 104A in this scenario includes the reliability of the connection between the UE 102 and the SN 106A by providing not only a primary secondary cell (PSCell) but also a conditional primary secondary cell (C-PSCell) to the UE 102 as part of the resume procedure. The UE 102 accordingly can switch to the C-PSCell if necessary, e.g., if a network-specified condition for switching from the PSCell to the C-PSCell is satisfied. As a more specific example, if the UE 102 successfully resumes the connection with the MN 104A but fails to connect to the SN 106A via the PSCell, the UE 102 can immediately retry to with the C-PSCell.

Now referring to FIG. 5B, a scenario 500B begins with an MR-DC release procedure 551 similar to the procedure 451 of FIG. 4B. Events in the scenario 500B similar to those discussed above with respect to the scenarios above are labeled with similar reference numbers; with the exception of the differences illustrated in FIG. 5B and the differences described below, any of the alternative implementations discussed above with respect to the above scenarios may apply to the scenario 500B.

The MN 104A sends 562B to the SN 106A an SN Modification Request message including an indication to reestablish lower layers. The SN 106A reestablishes 563B the lower layers and determines 561 that the SN 106A should generate a C-SN configuration for the UE 102 and include the C-SN configuration in the SN configuration. After the MN 104A receives 565 from the SN 106A an SN Modification Request Acknowledge with a second SN configuration enclosing the C-SN, the MN 104A sends 582 an RRC container message including the second SN configuration enclosing the C-SN configuration.

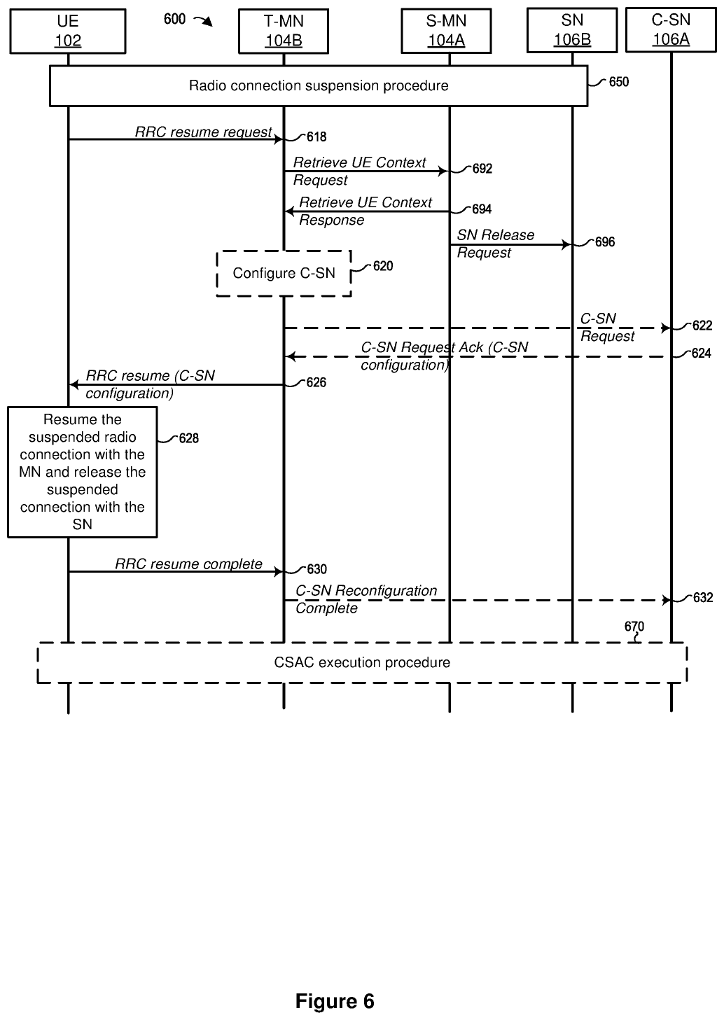

Now referring to FIG. 6, after the UE and RAN complete a radio connection suspension procedure 650 similar to procedures 350, 450, 550, the UE requests resumption of a radio connection through a target MN (T-MN) 104B rather than the prior MN now called the source MN (S-MN) 104A. Events in the scenario 600 similar to those discussed above with respect to the scenarios above are labeled with similar reference numbers. With the exception of the differences illustrated in FIG. 6 and the differences described below, any of the alternative implementations discussed above with respect to the above scenarios may apply to the scenario 600.

In the scenario 600, the source MN 104A, the SN 106B, and the UE 102 perform a radio connection suspension procedure 650, similar to the procedure 350. In this case, however, the UE 102 sends 618 an RRC resume request message on a cell of the T-MN 104B rather than a cell of the S-MN 104A. The T-MN 104B sends 692 a request to retrieve the context for the UE 102, to the MN 104A. The T-MN 104B receives 694 a response, and the S-MN 104A sends 696 an SN Release Request message to the SN 106B.

Then, similar to the scenario 300 of FIG. 3, the T-MN 104B then determines 620 that that it should configure a C-SN for the UE 102 and sends 622 an SN Request message to a base station 106A to request that the base station 106A operate as a C-SN for the UE 102. In response to the SN Request message, the C-SN 106A generates a C-SN configuration, includes the C-SN configuration in a SN Request Acknowledge message, and sends 624 the SN Request Acknowledge message to the T-MN 106.

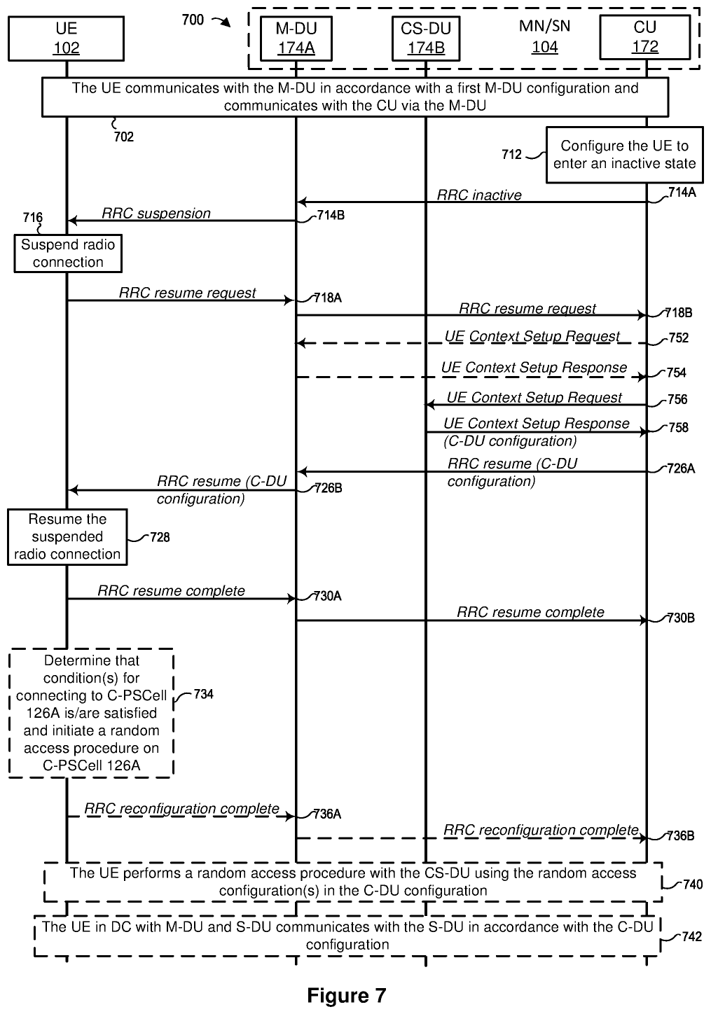

Referring to FIG. 7, the base station 104 in a scenario 700 is a distributed base station with a CU 172, a master DU (M-DU) 174A, and a candidate secondary DU (CS-DU) 174B. Events in the scenario 700 similar to those discussed above with respect to the scenarios above are labeled with similar reference numbers. With the exception of the differences illustrated in FIG. 6 and the differences described below, any of the alternative implementations discussed above with respect to the above scenarios may apply to the scenario 700.

Initially, the UE 102 communicates 702 data and control signals with the M-DU 174A, in accordance with the M-DU configuration. The UE 102 communicates with the CU 172 via the M-DU 174A. After the CU 172 determines 712 that it should configure the UE 102 to suspend the radio connection with the RAN and transition to the RRC inactive state, the CU 172 sends 714A an RRC inactive message to the M-DU 174A, and the M-DU 174A 104A sends 714B an RRC suspension message to the UE 102.

After receiving 718A the RRC resume request message, the M-DU 174 forwards 718B the RRC resume request message to the CU 172. The CU 172 optionally sends 752 a request to set up a UE context to the M-DU 174A, and receives 754 a response. The CU 172 then sends 756 a request to set up a UE context to the CS-DU 174B, and receives 758 a response enclosing a conditional DU (C-DU) configuration similar to the C-SN configuration. The CU 172 sends 726A an RRC resume message with the C-DU configuration to the M-DU 174A, which forwards 726B the RRC resume message with the C-DU configuration to the UE 102 via the radio interface.

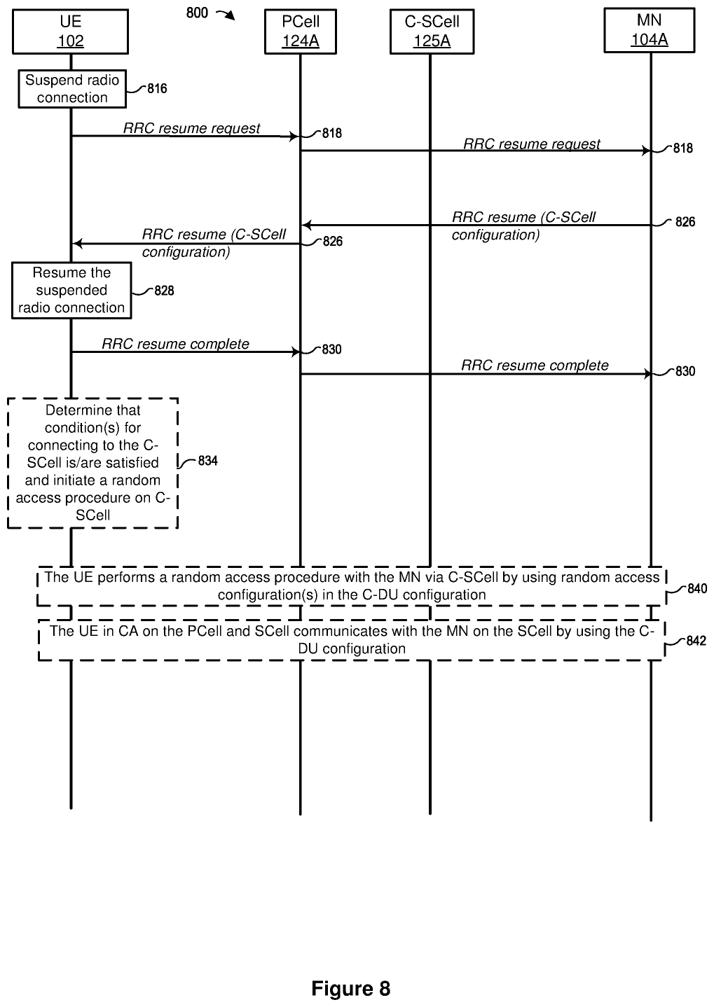

Now referring to FIG. 8, the UE 102 suspends 816 a radio connection and subsequently sends 818 an RRC resume request message to the MN 104A via the primary cell (PCell) 124A. For clarity, the PCell 124A and a candidate secondary cell (C-SCell) 125A are illustrated separately from the MN 104A. However, as illustrated in FIG. 1A, the MN 104A services the cell 124A as well as the cell 125A. The MN 104A sends 826 an RRC resume message including a C-SCell configuration to the UE 102, so that the UE 102 can utilize carrier aggregation if the one or more network-specified conditions for accessing the cell 125A are satisfied.

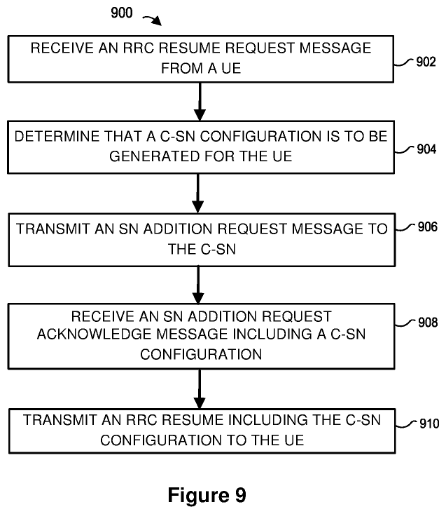

For further clarity, FIGS. 9-14 illustrate several example methods which a base station and/or a UE can implement to provide or receive a conditional configuration at an early opportunity.

Referring first to FIG. 9, an example method 900 for resuming a suspended a radio connection and providing conditional configuration to a UE can be implemented in a base station operating as an MN, e.g., the base station 104A. The method 900 begins at block 902, where the MN receives an RRC resume request message from the UE, such as the UE 102 (see event 318 of FIG. 3). At block 904, the MN determines that it should generate a C-SN configuration for the UE (see event 320 of FIG. 3). Then, at block 906, the MN sends an SN Addition Request message to a C-SN (see event 322 of FIG. 3). At block 908, the MN receives an SN Modification Request Acknowledge message with a C-SN configuration (see event 324 of FIG. 3). At block 910, the MN transmits an RRC resume message with the C-SN configuration to the UE (see event 326 of FIG. 3).

In this manner, the MN provides the conditional configuration to the UE at an early opportunity. Moreover, the MN eliminates the need for the UE to perform a C-SN configuration procedure.

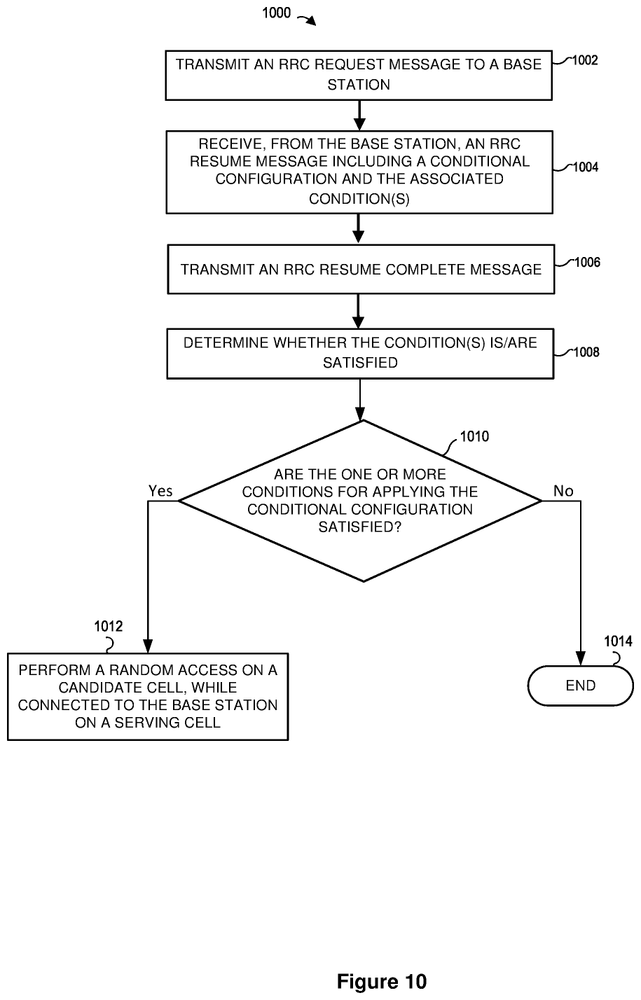

FIG. 10 illustrates a flow diagram of an example method 1000 for processing a conditional configuration, which can be implemented in the UE 102 or another suitable UE. At block 1002, the UE transmits an RRC resume request message to the base station (see event 318 of FIG. 3, 418A of FIG. 4A, 518A of FIG. 5A, 618 of FIG. 6, 718 of FIG. 7, 818 of FIG. 8). The UE then receives an RRC resume message including a conditional configuration and, in at least some of the implementations, one or more network-specified conditions for applying the conditional configuration (see events 326 of FIG. 3, 426A of FIG. 4A, 526A of FIG. 5A, 626 of FIG. 6, 726B of FIG. 7, 826 of FIG. 8). At block 1006, the UE transmits an RRC resume complete message to the RAN (see event 330 of FIG. 3, 430A of FIG. 4A, 530A of FIG. 5A, 630 of FIG. 6, 730A of FIG. 7A, 830 of FIG. 8).

At block 1008, the UE determines whether the one or more conditions are satisfied (see events 334 of FIG. 3, 734 of FIG. 7, 834 of FIG. 8). If the one or more conditions are satisfied, the flow proceeds to block 1012, where the UE performs a random access procedure on the candidate cell, while connected to the base station on a serving cell. In other words, the UE attempts to gain connectivity on multiple cells as part of dual connectivity or carrier aggregation for example, after resuming the connection on the primary cell (see events 340 of FIG. 3, 740 of FIG. 7, 840 of FIG. 8). Otherwise, if the one or more conditions are not satisfied, the method 1000 completes (termination point 1014).

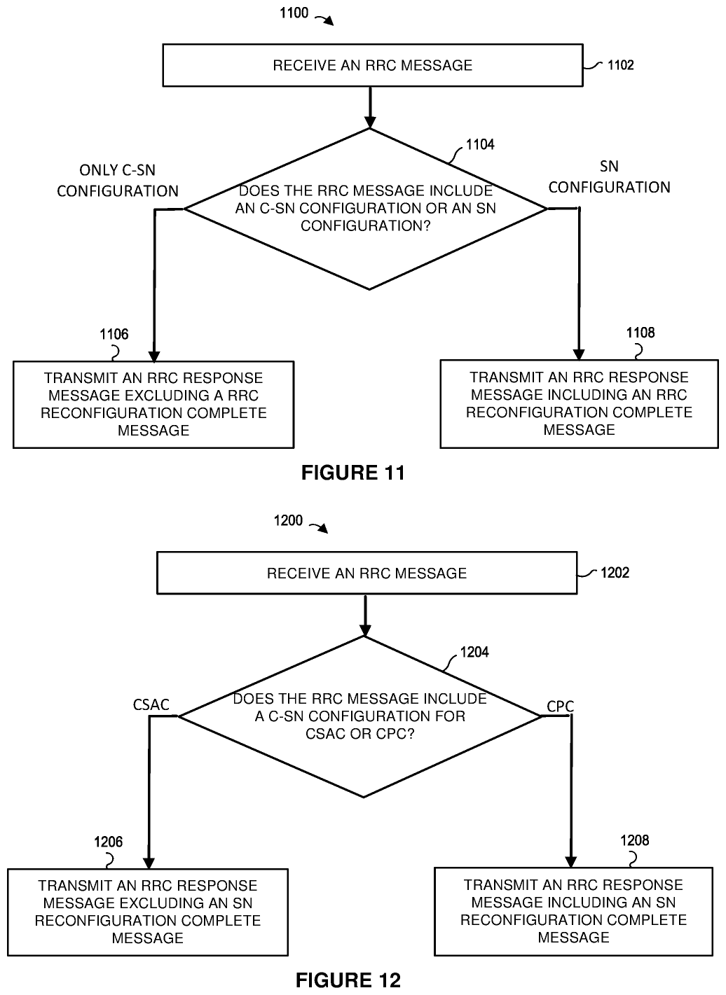

Next, FIG. 11 is a flow diagram of an example method for determining whether a UE should indicate that an RRC reconfiguration is completed, depending on whether the RAN provided conditional and/or non-conditional configuration, which can be implemented in the UE 102 or another suitable UE.

The method 1100 begins at block 1102, where the UE receives an RRC message. The RRC message can be for example an RRC resume message, an MN RRC reconfiguration message, or an RRC container message for example. If the UE determines at block 1104 that the RRC message contained only a C-SN configuration, the flow proceeds to block 1106 (see events 326 of FIG. 3, 626 of FIG. 6, 726B of FIG. 7, 826 of FIG. 8). Otherwise, if the RRC message includes only an (unconditional) SN configuration, or an SN configuration as well as a C-SN configuration, the flow proceeds to block 1108 (see events 426A of FIG. 4A, 482 of FIG. 4B, 526A of FIG. 5A, 582 of FIG. 5B).

At block 1106, the UE transmits an RRC response message that does not include an RRC reconfiguration complete message (see events of FIG. 3, 630 of FIG. 6, 730A of FIG. 7, 830 of FIG. 8). On the other hand, at block 1108, the UE transmits an RRC response message that includes an RRC reconfiguration complete message (see events 430A of FIG. 4A, 484B of FIG. 4B, 530A of FIG. 5A, 584 of FIG. 5B).

FIG. 12 illustrates a flow diagram of an example method 1200 for determining whether a UE should indicate that an RRC reconfiguration is completed, depending on whether the RAN provided a conditional configuration related to a secondary node or a primary secondary cell, which can be implemented in the UE 102 or another suitable UE. The method 1200 also begins with receiving an RRC message, at block 1202. At block 1202, the UE determines whether RRC message includes a conditional configuration for a CSAC procedure or a CPAC (or PCP) procedure. The flow proceeds to block 1206 if the conditional configuration pertains to CSAC, or to block 1208 if the conditional configuration pertains to CPC. At block 1206, the UE transmits an RRC response message that does not include an RRC reconfiguration complete message. On the other hand, at block 1208, the UE transmits an RRC response message that includes an RRC reconfiguration complete message.

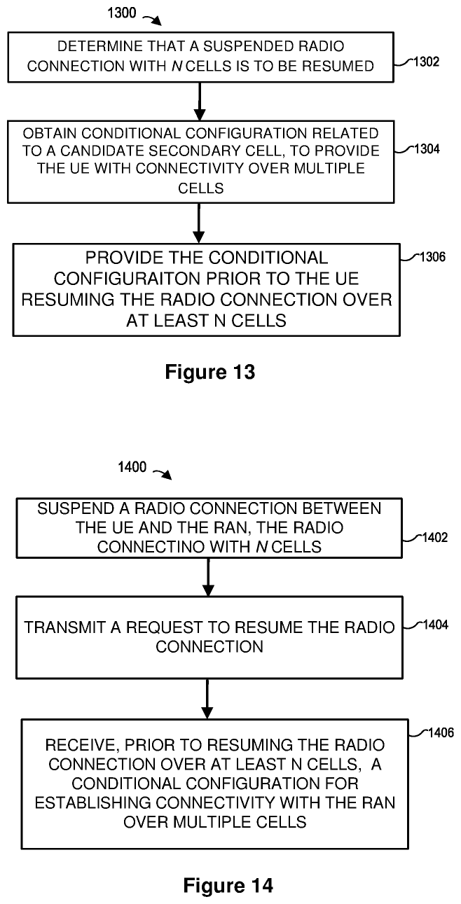

Next, FIG. 13 illustrates a flow diagram of an example method 1300 for providing a conditional configuration to a UE, which can be implemented in a base station of FIG. 1A.

At block 1302, the base station determines that a suspended radio connection with N cells is to be resumed, where N is an integer 1, 2, etc. The base station can make the determination at block 1302 based on a request from a UE for example (see events 318 of FIG. 3, 418A of FIG. 4A, 418B of FIG. 4B, 518A of FIG. 5A, 518B of FIG. 5B, 618 of FIG. 6, 718 of FIG. 7, 818 of FIG. 8). In the example of FIG. 3, the UE requests that an SC radio connection be resumed, and thus N=1. In the examples of FIG. 4A or 4B for example, the UE requests that an DC radio connection be resumed, and thus N=2.

At block 1304, the base station obtains a conditional configuration related to a candidate secondary cell (e.g., C-SN, CS-DU, C-SCell), so that the UE can establish a radio connection over multiple cells, subject to the one or more corresponding conditions being satisfied (see event 320 of FIG. 3, 421 of FIGS. 4A and 4B, 561/565 of FIGS. 5A and 5B, 620 of FIG. 6, 726A/726B of FIG. 7, 826 of FIG. 8). The radio connection the UE can establish can be a DC connection or a CA connection, for example.

At block 1306, the base station provides the the conditional configuration to the UE prior to the UE resuming the radio connection over at least N cells (see events 326 of FIG. 3, 426A of FIG. 4A, 526A of FIG. 5A, 626 of FIG. 6, 726B of FIG. 7, 826 of FIG. 8) or an RRC container message for example (see events 482 of FIG. 4B, 582B of FIG. 5B). For example, if the UE operated in SC or without carrier aggregation prior to suspension of the radio connection, the base station can provide the conditional configuration prior to the UE completing the procedure for resuming a radio connection over one cell (e.g., by including the conditional configuration in the RRC resume message). If the UE operated in DC prior to suspension of the radio connection, the base station can provide the conditional configuration prior to the UE resuming the connection with the secondary node.

FIG. 14 is a flow diagram of an example method 1400 for processing a conditional configuration received from a RAN, which can be implemented in the UE 102 or another suitable UE. The method 1400 begins at block 1402, where the UE suspends a radio connection between the UE and a RAN, where the radio connection is associated with N cells (see events 316 of FIG. 3, 416 of FIGS. 4A and 4B).

At block 1404, the UE transmits to the RAN a request to resume the suspended radio connection (see events 318 of FIG. 3, 418A of FIG. 4A, 418B of FIG. 4B, 518A of FIG. 5A, 518B of FIG. 5B, 618 of FIG. 6, 718 of FIG. 7, 818 of FIG. 8). Next, at block 1406, the UE receives from the RAN and prior to resuming the radio connection over at least N cells, the conditional configuration for establishing connectivity with the RAN over multiple cells (see events 326 of FIG. 3, 426A of FIG. 4A, 526A of FIG. 5A, 626 of FIG. 6, 726B of FIG. 7, 826 of FIG. 8) or an RRC container message for example (see events 482 of FIG. 4B, 582B of FIG. 5B).

The following description may be applied to the description above.

In some implementations, “message” is used and can be replaced by “information element (IE)”. In some implementations, “IE” is used and can be replaced by “field.” In some implementations, “configuration” can be replaced by “configurations” or the configuration parameters included in the C-SN configuration described above. For example, “C-SN configuration” can be replaced by “C-SN configurations.” The C-SN configuration can be replaced by a group configuration and/or radio bearer configuration.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of examples reflects a variety of the embodiments explicitly contemplated by the present disclosure.

Example 1. A method in a radio access network (RAN) for providing, to a user equipment (UE), a conditional configuration which the UE is to apply when a network-specified condition is satisfied, the method comprising: determining, by processing hardware, that a suspended radio connection between the UE and the RAN is to be resumed, the radio connection associated with N cells; obtaining, by the processing hardware, the conditional configuration related to a candidate secondary cell to provide the UE with connectivity over multiple cells; and providing, by the processing hardware, the conditional configuration to the UE prior to the UE resuming the radio connection over at least N cells.

Example 2. The method of example 1, wherein providing the conditional configuration includes providing a candidate secondary node (C-SN) configuration for a base station at which the suspended radio connection does not terminate.

Example 3. The method of example 2, wherein: the suspended radio connection is a single connectivity (SC) connection between the UE and a cell of a master mode (MN) operating in the RAN; and the C-SN configuration pertains to configuring the UE to operate in dual connectivity (DC) with the cell of the MN and a cell of the base station operating as a candidate SN.

Example 4. The method of example 2, wherein: the suspended radio connection is a DC connection between the UE, a cell of an MN, and a cell of a source SN; and the C-SN configuration pertains to configuring the UE to operate in DC with the cell of the MN and a cell of the base station operating as a candidate SN.

Example 5. The method of example 4, further comprising: providing, by the processing hardware and along with the C-SN configuration, a new SN configuration for the source SN, for resuming DC with the MN and the source SN prior to applying the C-SN configuration.

Example 6. The method of example 2, wherein: the suspended radio connection is a DC connection between the UE, a cell of a source MN, and a cell of a source SN; and the C-SN configuration pertains to configuring the UE to operate in DC with a cell of a target MN and a cell of the base station operating as a candidate SN.

Example 7. The method of example 1, wherein providing the conditional configuration includes providing a C-SN configuration for a base station at which the suspended radio connection terminates.

Example 8. The method of example 7, wherein: the suspended radio connection is a DC connection between the UE, a cell of an MN, and a first cell of the base station operating as a source SN; and the C-SN configuration pertains to configuring the UE to operate in DC with the cell of the MN and a second cell of the base station operating as a candidate SN.

Example 9. The method of example 8, further comprising: providing, by the processing hardware, new SN configuration for the source SN, for resuming DC with the MN and the source SN prior to applying the C-SN configuration, the new SN configuration enclosing the C-SN configuration.

Example 10. The method of example 1, wherein providing the conditional configuration includes providing a conditional distributed node (C-DU) configuration for a candidate secondary DU (CS-DU) in a distributed base station included in the suspended radio connection.

Example 11. The method of example 10, wherein: the suspended radio connection is a SC connection between the UE and a cell of a first DU of the distributed base station operating as a master DU (M-DU); and the C-DU configuration pertains to configuring the UE to operate in DC with the cell of the M-DU and a cell of the CS-DU.

Example 12. The method of example 1, wherein providing the conditional configuration includes providing a conditional secondary cell (C-SCell) configuration for a candidate secondary cell which the suspended radio connection does not include.

Example 13. The method of example 12, wherein: the suspended radio connection terminates at a primary cell of a base station; and the C-SCell configuration pertains to configuring the UE to operate in carrier aggregation (CA) with the primary cell and the candidate secondary cell.

Example 14. The method of any of the preceding examples, wherein providing the conditional configuration to the UE includes: transmitting a command to resume the suspended radio connection, the command associated with a protocol for controlling radio resources and including the conditional configuration.

Example 15. The method of example 14, wherein: obtaining the conditional configuration is in response to receiving, from the UE, a request to resume the suspended radio connection.

Example 16. The method of any of examples 1, 2, 4, 5, or 7-9, wherein providing the conditional configuration to the UE includes: transmitting a container message associated with a protocol for controlling radio resources, the container message including the conditional configuration.

Example 17. The method of example 16, further comprising: receiving, from the UE, a request to resume the suspended radio connection; transmitting, to the UE, a command to resume the suspended radio connection with an MN, the command including an SN configuration; and obtaining the conditional configuration is in response to receiving, from the UE, an indication that the UE has resumed the suspended radio connection with an MN.

Example 18. A base station comprising processing hardware and configured to implement according to any of the preceding examples.

Example 19. A method in a UE for obtaining a conditional configuration which the UE is to apply when a network-specified condition is satisfied, the method comprising: suspending, by processing hardware, a radio connection between the UE and a radio access network (RAN), the radio connection associated with N cells; transmitting, by the processing hardware to the RAN, a request to resume the suspended radio connection; and receiving, from the RAN and prior to resuming the radio connection over at least N cells, the conditional configuration for establishing connectivity with the RAN over multiple cells.

Example 20. The method of example 19, wherein receiving the conditional configuration includes receiving a candidate secondary node (C-SN) configuration for a base station at which the suspended radio connection does not terminate.

Example 21. The method of example 20, wherein: the suspended radio connection is a single connectivity (SC) connection between the UE and a cell of a master mode (MN) operating in the RAN; and the C-SN configuration pertains to configuring the UE to operate in dual connectivity (DC) with the cell of the MN and a cell of the base station operating as a candidate SN.

Example 22. The method of example 20, wherein: the suspended radio connection is a DC connection between the UE, a cell of an MN, and a cell of a source SN; and the C-SN configuration pertains to configuring the UE to operate in DC with the cell of the MN and a cell of the base station operating as a candidate SN.

Example 23. The method of example 22, further comprising: receiving, by the processing hardware and along with the C-SN configuration, a new SN configuration for the source SN, for resuming DC with the MN and the source SN prior to applying the C-SN configuration.

Example 24. The method of example 20, wherein: the suspended radio connection is a DC connection between the UE, a cell of a source MN, and a cell of a source SN; and the C-SN configuration pertains to configuring the UE to operate in DC with a cell of a target MN and a cell of the base station operating as a candidate.

Example 25. The method of example 19, wherein receiving the conditional configuration includes receiving a C-SN configuration for a base station at which the suspended radio connection terminates.

Example 26. The method of example 25, wherein: the suspended radio connection is a DC connection between the UE, a cell of an MN, and a first cell of the base station operating as a source SN; and the C-SN configuration pertains to configuring the UE to operate in DC with the cell of the MN and a second cell of the base station operating as a candidate SN.

Example 27. The method of example 26, further comprising: receiving, by the processing hardware, new SN configuration for the source SN, for resuming DC with the MN and the source SN prior to applying the C-SN configuration, the new SN configuration enclosing the C-SN configuration.

Example 28. The method of example 19, wherein receiving the conditional configuration includes receiving a conditional distributed node (C-DU) configuration for a candidate secondary DU (CS-DU) in a distributed base station included in the suspended radio connection.

Example 29. The method of example 28, wherein: the suspended radio connection is a SC connection between the UE and a cell of a first DU of the distributed base station operating as a master DU (M-DU); and the C-DU configuration pertains to configuring the UE to operate in DC with the cell of the M-DU and a cell of the CS-DU.

Example 30. The method of example 19, wherein receiving the conditional configuration includes receiving a conditional secondary cell (C-SCell) configuration for a candidate secondary cell which the suspended radio connection does not include.

Example 31. The method of example 30, wherein: the suspended radio connection terminates at a primary cell of a base station; and the C-SCell configuration pertains to configuring the UE to operate in carrier aggregation (CA) with the primary cell and the candidate secondary cell.

Example 32. The method of any of examples 1-19, wherein receiving the conditional configuration includes: receiving a command to resume the suspended radio connection, the command associated with a protocol for controlling radio resources and including the conditional configuration.

Example 33. The method of any of examples 19, 20, 22, 24, or 26-28, wherein receiving the conditional configuration includes: receiving a container message associated with a protocol for controlling radio resources, the container message including the conditional configuration.

Example 34. The method of example 32 or 33, further comprising: in response to the command or the container message, resuming the suspended radio connection over less than N cells; and transmitting, by the processing hardware to the RAN, a response to the command or the container message, the response excluding an indication that a radio connection has been reconfigured.

Example 35. The method of example 32 or 33, further comprising: determining, by the processing hardware, whether a response to the command or the container message should include an indication that a radio connection has been reconfigured based on whether the conditional configuration related to a (i) SN addition or change or (ii) primary secondary cell (PSCell) addition or change.

Example 36. A UE comprising processing hardware and configured to implement according to any of examples 19-35.

1. A method implemented in a radio access network (RAN) for providing, to a user equipment (UE), a conditional configuration which the UE is to apply when a network-specified condition is satisfied, the method comprising:
determining that a suspended radio connection between the UE and the RAN is to be resumed;
after the determining, obtaining the conditional configuration related to a candidate secondary cell to provide the UE with connectivity over multiple cells; and
providing the obtained conditional configuration to the UE prior to the UE resuming the radio connection over at least two cells.

2. The method of claim 1, wherein providing the conditional configuration includes providing a candidate secondary node (C-SN) configuration for a base station at which the suspended radio connection does not terminate.

3. The method of claim 2, wherein:
the suspended radio connection is (i) a single connectivity (SC) connection between the UE and a cell of a master mode (MN) operating in the RAN or (ii) a dual connectivity (DC) connection between the UE, a cell of the MN, and a cell of a source SN; and
the C-SN configuration pertains to configuring the UE to operate in DC with the cell of the MN and a cell of the base station operating as a candidate SN.

4. The method of claim 2, wherein:
the suspended radio connection is a DC connection between the UE, a cell of a source MN, and a cell of a source SN; and
the C-SN configuration pertains to configuring the UE to operate in DC with a cell of a target MN and a cell of the base station operating as a candidate SN.

5. The method of claim 1, wherein providing the conditional configuration includes providing a C-SN configuration for a base station at which the suspended radio connection terminates.

6. The method of claim 5, wherein:
the suspended radio connection is a DC connection between the UE, a cell of an MN, and a first cell of the base station operating as a source SN; and
the C-SN configuration pertains to configuring the UE to operate in DC with the cell of the MN and a second cell of the base station operating as a candidate SN.

7. The method of claim 1, wherein providing the conditional configuration includes providing a conditional distributed node (C-DU) configuration for a candidate secondary DU (CS-DU) in a distributed base station included in the suspended radio connection.

8. The method of claim 1, wherein providing the conditional configuration includes providing a conditional secondary cell (C-SCell) configuration for a candidate secondary cell which the suspended radio connection does not include.

9. A base station implemented in a radio access network (RAN), the base station comprising processing hardware and configured to:
determine that a suspended radio connection between a UE and the RAN is to be resumed;
after the determining, obtaining a conditional configuration which the UE is to apply when a network-specified condition is satisfied to provide the UE with connectivity over multiple cells, the conditional configuration related to a candidate secondary cell; and
providing the obtained conditional configuration to the UE prior to the UE resuming the radio connection over at least two cells.

10. A method implemented in a UE for obtaining a conditional configuration which the UE is to apply when a network-specified condition is satisfied, the method comprising:
suspending a radio connection between the UE and a radio access network (RAN);
transmitting, to the RAN, a request to resume the suspended radio connection; and
receiving, from the RAN after transmitting the request to resume the suspended radio connection and prior to resuming the radio connection over at least two cells, the conditional configuration for establishing connectivity with the RAN over multiple cells.

11. The method of claim 10, wherein:
the suspended radio connection is (i) a single connectivity (SC) connection between the UE and a cell of a master mode (MN) operating in the RAN or (ii) a DC connection between the UE, a cell of the MN, and a cell of a source SN; and
the C-SN configuration pertains to configuring the UE to operate in dual connectivity (DC) with the cell of the MN and a cell of the base station operating as a candidate SN.

12. The method of claim 10, wherein:
the suspended radio connection is a DC connection between the UE, a cell of a source MN, and a cell of a source SN; and the C-SN configuration pertains to configuring the UE to operate in DC with a cell of a target MN and a cell of the base station operating as a candidate.

13. The method of claim 10, wherein:
the suspended radio connection is a DC connection between the UE, a cell of an MN, and a first cell of the base station operating as a source SN; and
the C-SN configuration pertains to configuring the UE to operate in DC with the cell of the MN and a second cell of the base station operating as a candidate SN.

14. The method of claim 10, wherein receiving the conditional configuration includes:
receiving a command to resume the suspended radio connection, the command associated with a protocol for controlling radio resources and including the conditional configuration.

15. The method of claim 10, wherein receiving the conditional configuration includes:
receiving a container message associated with a protocol for controlling radio resources, the container message including the conditional configuration.

16. A UE comprising processing hardware and configured to:
suspend a radio connection between the UE and a radio access network (RAN);
transmit, to the RAN, a request to resume the suspended radio connection; and
receive, from the RAN after transmitting the request to resume the suspended radio connection and prior to resuming the radio connection over at least two cells, a conditional configuration for establishing connectivity with the RAN over multiple cells, which the UE is to apply when a network-specified condition is satisfied.

17. The base station of claim 9, wherein to provide the conditional configuration, the base station is configured to:
provide a candidate secondary node (C-SN) configuration for a base station at which the suspended radio connection does not terminate.

18. The base station of claim 17, wherein:
the suspended radio connection is (i) a single connectivity (SC) connection between the UE and a cell of a master mode (MN) operating in the RAN or (ii) a dual connectivity (DC) connection between the UE, a cell of the MN, and a cell of a source SN; and
the C-SN configuration pertains to configuring the UE to operate in DC with the cell of the MN and a cell of the base station operating as a candidate SN.

19. The UE of claim 16, wherein:
the suspended radio connection is (i) a single connectivity (SC) connection between the UE and a cell of a master mode (MN) operating in the RAN or (ii) a DC connection between the UE, a cell of the MN, and a cell of a source SN; and
the C-SN configuration pertains to configuring the UE to operate in dual connectivity (DC) with the cell of the MN and a cell of the base station operating as a candidate SN.

20. The UE of claim 16, wherein:
the suspended radio connection is a DC connection between the UE, a cell of a source MN, and a cell of a source SN; and the C-SN configuration pertains to configuring the UE to operate in DC with a cell of a target MN and a cell of the base station operating as a candidate.
